(19) United States
(12) Patent Application Publication
(10) Pub. No.: US 2021/0151775 A1
(43) Pub. Date: May 20, 2021

(54) HYDROGEN OXIDATION ELECTRODES AND ELECTROCHEMICAL CELLS INCLUDING THE SAME

(71) Applicant: FORM ENERGY INC.,, Somerville, MA (US)

(72) Inventors: Nicholas Reed PERKINS, Cambridge, MA (US); Eric WEBER, Pittsburgh, PA (US); Benjamin Thomas HULTMAN, Somerville, MA (US); Ian Salmon MCKAY, Seattle, WA (US); Jarrod David MILSHTEIN, Arlington, MA (US); Liang SU, Medfield, MA (US); Andrew LIOTTA, Cambridge, MA (US); Jocelyn Marie NEWHOUSE, Somerville, MA (US); William Henry WOODFORD, Cambridge, MA (US); Annelise Christine THOMPSON, Medford, MA (US); Danielle Cassidy SMITH, Cambridge, MA (US)

(21) Appl. No.: 16/951,396

(22) Filed: Nov. 18, 2020

Related U.S. Application Data
(60) Provisional application No. 62/937,439, filed on Nov. 19, 2019.
(60) Provisional application No. 63/020,743, filed on May 6, 2020.

(51) Int. Cl. H01M 4/90; H01M 8/08

(52) U.S. Cl. CPC H01M 4/90; H01M 8/08

(57) ABSTRACT

Materials, designs, and methods of fabrication for hydrogen oxidation electrodes and electrochemical cells including the same are disclosed. In various embodiments, hydrogen oxidation catalysts and corresponding substrates are provided that enable electrochemical oxidation of hydrogen evolved at the anode of aqueous batteries.

### RELATED APPLICATIONS

This application claims the benefit of priority to U.S. Provisional Patent Application No. 62/937,439 entitled “Hydrogen Oxidation Electrodes And Electrochemical Cells Including The Same” filed Nov. 19, 2019 and U.S. Provisional Patent Application No. 63/020,743 entitled “Hydrogen Oxidation Electrodes And Electrochemical Cells Including The Same” filed May 6, 2020. The entire contents of both applications are hereby incorporated by reference for all purposes.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years.

This Background section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

Materials, designs, and methods of fabrication for hydrogen oxidation catalysts, hydrogen absorption materials, electrodes, and electrochemical cells including the same are disclosed. In various embodiments, hydrogen oxidation catalysts and corresponding substrates are provided that enable chemical oxidation of hydrogen evolved at the negative electrode (anode) of aqueous batteries. In various embodiments, materials are provided that enable the absorption or storage of hydrogen in a solid phase. In various embodiments, the hydrogen is oxidized by flowing the hydrogen gas over an alkaline (pH>11) electrolyte. In various embodiments, hydrogen oxidation catalysts and corresponding substrates are provided that enable electrochemical oxidation of hydrogen evolved at the negative electrode (anode) of aqueous batteries.

Various embodiments may provide chemical methods of hydrogen recombination. Various embodiments may provide chemical methods of oxidizing hydrogen. In some embodiments, the chemical oxidation may be used to scavenge the hydrogen to mitigate safety challenges associated with free hydrogen gas. In some embodiments, the chemical oxidation may be used to recombine hydrogen with oxygen to reduce the rate of liquid water loss from an electrochemical cell.

Various embodiments may provide electrochemical methods of hydrogen recombination. Various embodiments may provide methods of electrochemically oxidizing hydrogen. In some embodiments, the electrochemical oxidation can be performed to collect the hydrogen produced as a byproduct at aqueous battery anodes, using the byproduct hydrogen as a fuel to reclaim some of the energy lost due to the hydrogen gas creation in the first place. In some embodiments, the electrochemical oxidation can be used to scavenge the hydrogen to mitigate safety challenges associated with free hydrogen gas. Various embodiments may include electrochemical systems including two separate electrochemical circuits, such as a hydrogen oxidation reaction (HOR) electrode including circuit and an oxygen evolution reaction (OER) electrode including circuit that may be operated simultaneously. Various embodiments may enable combinations of voltage, power, and current control between the electrodes of such multiple electrochemical circuit systems. Various embodiments include methods of directing hydrogen gas to an electrode performing the hydrogen oxidation reaction (HOR).

Various embodiments may provide three electrode hydrogen oxidation configurations. Various embodiments include three electrode electrochemical cells that electrochemically oxidize hydrogen. Various embodiments include methods of oxidizing hydrogen to recapture electrons into a charging circuit. Various embodiments include methods of directing hydrogen gas to an electrode performing the hydrogen oxidation reaction (HOR). Various embodiments include methods of directing hydrogen to an electrode performing other electrochemical reactions.

Various embodiments may provide catalysts and substrates for use as a hydrogen oxidation electrode. In some embodiments, the hydrogen oxidation electrode may include a catalyst layer disposed on a substrate. In some embodiments, the catalyst layer may include various combinations of Ni, Mo, Mn, Co, C, Cu, N, Si, Al, Fe, Ti, Cr, and La. In some embodiments, the substrate layer may include various combinations of Ni, Fe, C, Cu, Ti. In some embodiments, the substrate layer may be comprised of a porous metal. In some embodiments, the porous metal may be comprised of sintered metal particles, a metal foam, metal wool, or metal fibers. In some embodiments, the substrate layer may be comprised of a porous carbon. In some embodiments, the porous carbon may be comprised of a carbon felt, carbon paper, carbon particles, carbon cloth, or carbon fibers.

In various embodiments, noble metals, such as Pt, Pd, Au, or Ag, are the primary catalysts for the electrochemical oxidation of hydrogen. In some embodiments, the noble metal catalyst is mixed with an electronically conductive carbon, such as graphite, carbon black, or acetylene black, to increase the rate of hydrogen oxidation in the packed catalyst bed. In some embodiments, multiple metal catalysts are mixed to increase electrochemical hydrogen oxidation rates. In some embodiments, the noble metal catalyst is alloyed with a transition metal, such as Ni, to increase the catalytic activity of the catalyst metal.

In various embodiments, manganese oxides (MnOx) are the primary catalysts for the electrochemical oxidation of hydrogen. In some embodiments, the MnOx species are MnO, Mn₃O₄, Mn₂O₃, MnOOH, MnO₂, or combinations thereof. In some embodiments, MnO₂ is alfa-, beta-, gamma-, delta-, lamda-, epsilon-MnO₂, or combinations thereof. In some embodiments, MnO₂ is natural MnO₂. In some embodiments, MnO₂ is electrolytic manganese dioxide (EMD). In some embodiments, MnOx is doped by transition metals, such as nickel, magnesium, cobalt, iron, or combinations thereof. In some embodiments, MnOx is doped by metals, such as nickel, magnesium, cobalt, iron, or combinations thereof. In some embodiments, MnOx is mixed with metals, such as nickel, magnesium, cobalt, iron, or combinations thereof. In some embodiments, MnOx is mixed with a transition metal oxide (such as Bi₂O₃) or metal sulfide (such as Bi₂S₃), or combinations thereof.

Various embodiments may provide an electrochemical cell comprising: a battery negative electrode; a hydrogen oxidation reaction (HOR) electrode; an oxygen evolution reaction (OER) electrode; an oxygen reduction reaction (ORR) electrode; and an electrolyte. In certain embodiments, the battery negative electrode produces hydrogen gas as a byproduct during the charge process, discharge process, or rest. In some embodiments, the electrochemical cell contains an alkaline electrolyte (pH>11), wherein the electrolyte is comprised of water and one or more of the following hydroxide salts: lithium hydroxide, sodium hydroxide, potassium hydroxide. In some embodiments, the battery negative electrode is comprised of one or more of the following metals: Al, Zn, Fe, Cd, Mg. In various embodiments containing an iron battery negative electrode (e.g., an iron battery anode), the iron battery negative electrode may be comprised of one or more types of sintered iron powders: sponge iron powder, atomized iron powder, carbonyl iron powder. In various embodiments containing an iron battery negative electrode, the iron battery negative electrode may be comprised of direct reduced iron (DRI).

Various embodiments may provide an electrochemical cell comprising: a battery negative electrode; an oxygen evolution reaction (OER) electrode; and a bifunctional oxygen reduction reaction (ORR)/hydrogen oxidation reaction (HOR) electrode. In such an embodiment, the bifunctional electrode operates as an oxygen reduction reaction (ORR) electrode while the battery negative electrode is discharging, and the bifunctional electrode operates as a hydrogen oxidation reaction (HOR) electrode while the battery negative electrode is charging or at rest. In certain embodiments, the battery negative electrode produces hydrogen gas as a byproduct during the charge process, discharge process, or rest. In some embodiments, the electrochemical cell contains an alkaline electrolyte (pH>11), wherein the electrolyte is comprised of water and one or more of the following hydroxide salts: lithium hydroxide, sodium hydroxide, potassium hydroxide. In some embodiments, the battery negative electrode is comprised of one or more of the following metals: Al, Zn, Fe, Cd, Mg. In various embodiments containing an iron battery negative electrode, the iron battery negative electrode may be comprised of one or more types of sintered iron powders: sponge iron powder, atomized iron powder, carbonyl iron powder. In various embodiments containing an iron battery negative electrode, the iron battery negative electrode may be comprised of direct reduced iron (DRI).

Various embodiments may provide an electrochemical cell comprising: a battery negative electrode; a battery positive electrode; and a hydrogen oxidation reaction (HOR) electrode. In various embodiments, the battery positive electrode may be comprised of manganese dioxide. The battery positive electrode may contain a mixture of manganese dioxide, carbon, and a polymeric binder. In such an embodiment, the HOR electrode preforms the hydrogen oxidation reaction while the battery negative electrode is charging or at rest. In certain embodiments, the battery negative electrode produces hydrogen gas as a byproduct during the charge process, discharge process, or rest. In some embodiments, the electrochemical cell contains an alkaline electrolyte (pH>11), wherein the electrolyte is comprised of water and one or more of the following hydroxide salts lithium hydroxide, sodium hydroxide, potassium hydroxide. In some embodiments, the battery negative electrode is comprised of one or more of the following metals: Al, Zn, Fe, Cd, Mg. In various embodiments containing an iron battery negative electrode, the iron battery negative electrode may be comprised of one or more types of sintered iron powders: sponge iron powder, atomized iron powder, carbonyl iron powder. In various embodiments containing an iron battery negative electrode, the iron battery negative electrode may be comprised of direct reduced iron (DRI).

Various embodiments may provide a hydrogen oxidation reaction (HOR) electrode comprising: a substrate, and a catalyst layer disposed on the substrate. In some embodiments, the catalyst layer may include various combinations of Ni, Mo, Mn, Co, C, Cu, N, Si, Al, Fe, Ti, Cr, and La. In some embodiments, the substrate layer may include various combinations of Ni, Fe, C, Cu, Ti. In some embodiments, the substrate layer may be comprised of a porous metal. In some embodiments, the porous metal may be comprised of sintered metal particles, a metal foam, metal wool, or metal fibers. In some embodiments, the substrate layer may be comprised of a porous carbon. In some embodiments, the porous carbon may be comprised of a carbon felt, carbon paper, carbon particles, carbon cloth, or carbon fibers.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a schematic view of an electrochemical system according to various embodiments of the present disclosure.

FIG. 1B is a schematic view showing a voltage difference of an alternative configuration of an electrochemical cell of the system of FIG. 1A.

FIG. 1C is a schematic electrochemical reaction illustrating the implementation of a HOR electrode to reduce the rate of self-discharge of a battery negative electrode comprised of iron.

FIG. 2 is a schematic view showing a collection device that may be included in an electrochemical cell according to various embodiments of the present disclosure.

FIG. 3A is a schematic view of an electrochemical cell having a three-terminal configuration during discharging according to an embodiment.

FIG. 3B is a schematic view of the electrochemical cell of FIG. 3A during recharging.

FIG. 4 is a schematic view of an embodiment three terminal configuration of an electrochemical cell having a dual HOR/ORR electrode.

FIG. 5 is a schematic view of another embodiment three terminal configuration of an electrochemical cell.

FIG. 6 is a schematic view of another embodiment three terminal configuration of an electrochemical cell.

FIG. 7 is a schematic view of an electrochemical cell containing an iron (Fe) negative electrode, a MnO₂ positive electrode, and an HOR electrode.

FIG. 8A is a schematic view of an electrochemical system according to various embodiments of the present disclosure, including a funnel to direct hydrogen gas.

FIG. 8B is a schematic view of an electrochemical system according to various embodiments of the present disclosure, including a mechanical barrier to direct hydrogen gas.

FIG. 9 is a schematic view of an electrochemical system according to various embodiments of the present disclosure.

FIG. 10 is a graph showing hydrogen recombination power output vs. voltage applied to an HOR catalyst electrode, according to various embodiments of the present disclosure.

FIG. 11 is a graph showing energy recovery efficiency and voltage efficiency of a battery according to various embodiments of the present disclosure.

FIG. 12 is a graph showing cell potential vs. current of a battery according to various embodiments of the present disclosure.

FIG. 13 is a schematic view of a hydrogen oxidation catalyst or hydrogen absorption material coated to the inside of the lid of an electrochemical cell.

FIG. 14 is a schematic view of a vented cartridge located inside the mechanical housing of an electrochemical cell. The cartridge may contain either a hydrogen oxidation catalyst or hydrogen absorption material.

FIG. 15 is a schematic view of a vented cartridge containing either a hydrogen oxidation catalyst or hydrogen absorption material.

FIG. 16 is a schematic microstructure of a hydrogen oxidation catalyst impregnated into the negative electrode of a battery.

FIG. 17 is a schematic microstructure of a hydrogen absorption material impregnated into the negative electrode of a battery.

FIGS. 18-26 illustrate various example systems in which one or more aspects of the various embodiments may be used as part of bulk energy storage systems.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention. Unless otherwise noted, the accompanying drawings are not drawn to scale.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Generally, the term “about” and the symbol “˜” as used herein unless specified otherwise is meant to encompass a variance or range of +10%, the experimental or instrument error associated with obtaining the stated value, and preferably the larger of these.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

As used herein, unless specified otherwise the terms %, weight % and mass % are used interchangeably and refer to the weight of a first component as a percentage of the weight of the total, e.g., formulation, mixture, particle, pellet, agglomerate, material, structure or product. As used herein, unless specified otherwise “volume %” and “% volume” and similar such terms refer to the volume of a first component as a percentage of the volume of the total, e.g., formulation, mixture, particle, pellet, agglomerate, material, structure or product.

The following examples are provided to illustrate various embodiments of the present systems and methods of the present inventions. These examples are for illustrative purposes, may be prophetic, and should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A∝, C and D can be used with each other in various combination, e.g., A, C, D, and A. A″ C and D, etc., in accordance with the teaching of this specification. Thus, the scope of protection afforded to the present inventions should not be limited to a particular embodiment, configuration or arrangement that is set forth in a particular embodiment, example, or in an embodiment in a particular figure.

Various embodiments are discussed in relation to the use of direct reduced iron (DRI) as a material a battery (or cell), as a component of a battery (or cell) and combinations and variations of these. In various embodiments, the DRI may be produced from, or may be, material which is obtained from the reduction of natural or processed iron ores, without reaching the melting temperature of iron. In various embodiments the iron ore may be taconite or magnetite or hematite or goethite, etc. In various embodiments, the DRI may be in the form of pellets, which may be spherical or substantially spherical. In various embodiments the DRI may be porous, containing open and/or closed internal porosity. In various embodiments the DRI may comprise materials that have been further processed by hot or cold briquetting. In various embodiments, the DRI may be produced by reducing iron ore pellets to form a more metallic (more reduced, less highly oxidized) material, such as iron metal (Fe⁰), wustite (FeO), or a composite pellet comprising iron metal and residual oxide phases. In various non-limiting embodiments, the DRI may be reduced iron ore (such as taconite), reduced “Direct Reduction (DR) Grade” pellets, reduced “Blast Furnace (BF) Grade” pellets, reduced “Electric Arc Furnace (EAF)-Grade” pellets. “Cold Direct Reduced Iron (CDRI)” pellets, direct reduced iron (“DRI”) pellets, Hot Briquetted Iron (HBI), or any combination thereof. In the iron and steelmaking industry, DRI is sometimes referred to as “sponge iron;” this usage is particularly common in India. Embodiments of iron materials, including for example embodiments of DRI materials, for use in various embodiments described herein, including as electrode materials, may have, one, more than one, or all of the material properties as described in Table 1 below. As used in the Specification, including Table 1, the following terms, have the following meaning, unless expressly stated otherwise: “Specific surface area” means, the total surface area of a material per unit of mass, which includes the surface area of the pores in a porous structure; “Carbon content” or “Carbon (wt %)” means the mass of total carbon as percent of total mass of DRI; “Cementite content” or “Cementite (wt %)” means the mass of Fe₃C as percent of total mass of DRI; “Total Fe (wt %)” means the mass of total iron as percent of total mass of DRI; “Metallic Fe (wt %)” means the mass of iron in the Fe⁰ state as percent of total mass of DRI; and “Metallization” means the mass of iron in the Fe⁰ state as percent of total iron mass.

TABLE 1

| Material Property | Embodiment Range |
|---|---|
| Specific surface area* | 0.19-0.46 m²/g as received or 0.19-18 |
| | m²/g after performing a pre-charge |
| | formation step |
| True density (as determined by helium (He) | 4.6-7.1 g/cc |
| gas pycnometry) | |
| Porosity | 51-70% |
| Minimum d_{pore, 90% volume}** | 50 nm-50 μm |
| Minimum dpore, 50% surface area*** | 1 nm-10 μm |
| Total Fe (wt %) | 69.9-89.8% |
| Metallic Fe (wt %) | 46.5-85% |
| Metallization (%) | 59.5-96% |
| Carbon (wt %) | «3.7% |
| Fe²⁺ (wt %) | 1-9% |
| Fe³⁺ (wt %) | 0.9-25% |
| SiO₂ (wt %) | 2-15% |
| Ferrite (wt %, XRD) | 22-97% |
| Wustite (FeO, wt %, XRD) | 0-13% |
| Goethite (FeOOH, wt %, XRD) | 0-23% |
| Cementite (Fe₃C, wt %, XRD) | «80% |

*As preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.
**90% of the pore volume is in pores of diameter greater than d_{pore, 90% volume.}
***50% of free surface area is in pores of diameter greater than dpore, 50% surface area.

Additionally, embodiments of iron materials, including for example embodiments of DRI materials, for use in various embodiments described herein, including as electrode materials, may have one or more of the following properties, features or characteristics, (noting that values from one row or one column may be present with values in different rows or columns) as set forth in Table 1A.

TABLE 1A

| | | | | |
|---|---|---|---|---|
| Fe total (wt %) | >50% | >60% | >65% | ~67-69% |
| SiO2 (wt %) | <2% | <1.5% | <1% | 1.6-0.9% |
| CaO (wt %) | <1.6% | <1% | <0.9% | 1.5-0.8% |
| Cold crushing | >100 | >150 | ~125-275 | ~280 to ~340 |
| Strength^{!} | | | | |
| (daN/p) (where | | | | |
| 1 daN = 10N = | | | | |
| 1.02 kp) | | | | |
| Cold crush | No more than | No more than | No more than | No more than |
| strength | 10% having | 5% having cold | ~20% having | ~10% having |
| distribution in | cold crush | crush strength | cold crush | cold crush |
| particle | strength below | below 150 daN | strength below | strength below |
| population^{!!} | 200 daN | | average daN | average daN |
| Size (largest | <10 mm | ~5-20 mm | ~10 to ~25 mm | >25 mm |
| cross-sectional | | | | |
| distance, e.g. | | | | |
| for a sphere the | | | | |
| diameter) | | | | |
| Fines | <10% | <5% | 0 to ~15% | <35% |
| Actual Density | ~5 | 4.9-5.3 | ~4.0 to ~6.5 | <7.8 |
| g/cm³ | | | | |
| Apparent | ~3.6 | 2-5 | ~3.4 to ~3.9 | <10 |
| Density g/cm³ | | | | |
| Porosity (%) | >15 | ~20-90 | ~25 to ~35 | >50 |

^{!}Preferably, as determined by ISO 4700: 20073 the entire disclosure of which is incorporated herein by reference.
^{!!}Preferably, as determined by ISO 4700: 2007 the entire disclosure of which is incorporated herein by reference.

The properties set forth in Table 1, may also be present in embodiments with, in addition to, or instead of the properties in Table 1A. Greater and lesser values for these properties may also be present in various embodiments.

In embodiments the specific surface area for the pellets can be from about 0.05 m²/g to about 35 m²/g, from about 0.1 m²/g to about 5 m²/g, from about 0.5 m²/g to about 10 m²/g, from about 0.2 m²/g to about 5 m²/g, from about 1 m²/g to about 5 m²/g, from about 1 m²/g to about 20 m²/g, greater than about 1 m²/g, greater than about 2 m²/g, less than about 5 m²/g, less than about 15 m²/g, less than about 20 m²/g, and combinations and variations of these, as well as greater and smaller values.

In general, iron ore pellets are produced by crushing, grinding or milling of iron ore to a fine powdery form, which is then concentrated by removing impurity phases (so called “gangue”) which are liberated by the grinding operation. In general, as the ore is ground to finer (smaller) particle sizes, the purity of the resulting concentrate is increased. The concentrate is then formed into a pellet by a pelletizing or balling process (using, for example, a drum or disk pelletizer). In general, greater energy input is required to produce higher purity ore pellets. Iron ore pellets are commonly marketed or sold under two principal categories: Blast Furnace (BF) grade pellets and Direct Reduction (DR Grade) (also sometimes referred to as Electric Arc Furnace (EAF) Grade) with the principal distinction being the content of SiO₂ and other impurity phases being higher in the BF grade pellets relative to DR Grade pellets. Typical key specifications for a DR Grade pellet or feedstock are a total Fe content by mass percentage in the range of 63-69 wt % such as 67 wt % and a SiO₂ content by mass percentage of less than 3 wt % such as 1 wt %. Typical key specifications for a BF grade pellet or feedstock are a total Fe content by mass percentage in the range of 60-67 wt % such as 63 wt % and a SiO₂ content by mass percentage in the range of 2-8 wt % such as 4 wt %.

In certain embodiments the DRI may be produced by the reduction of a “Blast Furnace” pellet, in which case the resulting DRI may have material properties as described in Table 2 below. The use of reduced BF grade DRI may be advantageous due to the lesser input energy required to produce the pellet, which translates to a lower cost of the finished material.

TABLE 2

| Material Property | Embodiment Range |
|---|---|
| Specific surface area* | 0.21-0.46 m²/g as received or 0.21-18m²/ |
| | g after performing a pre-charge |
| | formation step |
| True density (as determined by helium (He) | 5.5-6.7 g/cc |
| gas pycnometry) | |
| Porosity | 57-71% |
| Minimum d_{pore, 90% volume}** | 50 nm-50 μm |
| Minimum dpore, 50% surface area*** | 1 nm-10 μm |
| Total Fe (wt %) | 81.8-89.2% |
| Metallic Fe (wt %) | 68.7-83.2% |
| Metallization (%) | 84-95% |
| Carbon (wt %) | 0.03-0.35% |
| Fe²⁺ (wt %) | 2-8.7% |
| Fe³⁺ (wt %) | 0.9-5.2% |
| SiO₂ (wt %) | 5.5-6.7% |
| Ferrite (wt %, XRD) | 80-96% |
| Wustite (FeO, wt %, XRD) | 2-13% |
| Goethite (FeOOH, wt %, XRD) | 0-11% |
| Cementite (Fe₃C, wt %, XRD) | 0-80% |

*As preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.
**90% of the pore volume is in pores of diameter greater than d_{pore, 90% volume.}
***50% of free surface area is in pores of diameter greater than dpore, 50% surface area.

The properties set forth in Table 2, may also be present in embodiments with, in addition to, or instead of the properties in Tables 1 and/or 1A. Greater and lesser values for these properties may also be present in various embodiments.

In certain embodiments the DRI may be produced by the reduction of a DR Grade pellet, in which case the resulting DRI may have material properties as described in Table 3 below. The use of reduced DR grade DRI may be advantageous due to the higher Fe content in the pellet which increases the energy density of the battery.

TABLE 3

| Material Property | Embodiment Range |
|---|---|
| Specific surface area* | 0.1-0.7 m²/g as received or 0.19-25 m²/ |
| | g after performing a pre-charge formation step |
| True density (as determined by helium (He) | 4.6-7.1 g/cc |
| gas pycnometry) | |
| Porosity | 51-80% |
| Minimum d_{pore, 90% volume}** | 50 nm-50 μm |
| Minimum dpore, 50% surface area*** | 1 nm-10 μm |
| Total Fe (wt %) | 80-94% |
| Metallic Fe (wt %) | 64-94% |
| Metallization (%) | 80-100% |
| Carbon (wt %) | «3.7% |
| Fe²⁺ (wt %) | 0-8% |
| Fe³⁺ (wt %) | 0-10% |
| SiO₂ (wt %) | 0-4% |
| Ferrite (wt %, XRD) | 22-80% |
| Wustite (FeO, wt %, XRD) | 0-13% |
| Goethite (FeOOH, wt %, XRD) | 0-23% |
| Cementite (Fe₃C, wt %, XRD) | «80% |

*As preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.
**90% of the pore volume is in pores of diameter greater than d_{pore, 90% volume.}
***50% of free surface area is in pores of diameter greater than dpore, 50% surface area.

The properties set forth in Table 3, may also be present in embodiments with, in addition to, or instead of the properties in Tables 1, 1A, and/or 2. Greater and lesser values for these properties may also be present in various embodiments.

In various embodiments, a bed of conductive pellets comprise (e.g., function to provide, are a component of, constitute, etc.) an electrode in an energy storage system. In embodiments of this electrode the pellets comprise, an iron containing material, a reduced iron material, iron in a non-oxidized state, iron in a highly oxidized state, iron having a valence state between 0 and 3+ and combinations and variations of these. In embodiments of this electrode the pellets comprise iron having one or more of the features set forth in Tables 1, 1A, 2, and 3. In embodiments the pellets have porosity, for example open pore structures, that can have pore sizes, for example, ranging from a few nanometers to several microns. For example, embodiments may have pore sizes from about 5 nm (nanometers) to about 100 μm (microns), about 50 nm to about 10 μm, about 100 nm to about 1 μm, greater than 100, nm, greater than 500 nm, less than 1 μm, less than 10 μm, less than 100 μm and combinations and variations of these pore sizes as well as larger and smaller pores. In some embodiments, the pellets comprise pellets of direct reduced iron (DRI). Embodiments of these electrodes in the energy storage system, and in particular in long duration energy storage systems, may have one or more of these foregoing features.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal conductive elements in parallel. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electronic current and ionic current flowing in an opposite direction as that of a discharging battery in service.

The present invention relates to materials, electrodes and methods for electrochemical cells, including batteries where the negative electrode produces hydrogen gas as a byproduct and employing a hydrogen oxidation electrode to oxidize the hydrogen gas. As used herein, the term “battery negative electrode” refers to a negative electrode of a battery, such as a metal negative electrode of a metal air battery, that may be a charge-storing electrode. As used herein, the term “battery positive electrode” refers to a positive electrode of a battery, such as a manganese dioxide (MnO₂) electrode of a metal-MnO₂ battery, that may be a charge-storing electrode.

Alkaline batteries, especially those employing an aluminum, magnesium, zinc, or iron-based battery negative electrode, generate hydrogen gas at the battery negative electrode during operation. Such hydrogen gas generation is a safety challenge and is a source of energy inefficiency. Accordingly, there is a need for an energy storage system that can adaptively respond to hydrogen production during different cell operation protocols to mitigate safety hazards and improve operating efficiency.

For example, in alkaline batteries that include iron battery negative electrodes, such as iron-air, iron-nickel, and iron-MnO₂ batteries, the electrochemical production of hydrogen may occur during charging and self-discharge, and is a primary source of coulombic efficiency loss. During charging, hydrogen gas can be produced at the surface of the battery negative electrode as a competing side reaction, according to the following electrochemical reaction: 2H₂O+2e⁻→H_{2(g)}+2OH⁻_{(aq)}. Hydrogen gas can also be produced during self-discharge of the iron battery negative electrode according to the following chemical reaction: Fe+2H₂O→Fe(OH)₂+H_{2(g)}.

Conventionally, for safety reasons, the generated hydrogen is vented from battery cells. This venting operation often requires the implementation of expensive ventilation infrastructure for large arrays of deployed battery cells. Operating ventilation systems to remove hydrogen from the ambient environment introduces additional system inefficiencies, further reducing the amount of usable energy delivered by a battery system. Accordingly, there is a need for electrochemical cells, such as iron-based batteries, that include improved hydrogen gas management systems.

Four-Electrode Electrochemical Cells

According to various embodiments of the present disclosure, provided are electrochemical cells, battery systems, and methods that efficiently consume generated hydrogen via electrochemical oxidation. The electrochemical oxidation process can include collecting hydrogen gas and utilizing the collected hydrogen as a fuel in an electrochemical cell to reclaim some of the energy consumed while producing the hydrogen. Alternatively, the electrochemical oxidation can be used purely to scavenge hydrogen to mitigate safety challenges associated with free hydrogen gas. In some embodiments, electrochemical systems are provided that include batteries having separate electrochemical circuits for simultaneous hydrogen consumption and power storage/discharge. Such electrochemical cells may include four electrodes and various voltage, power, and current control configurations therebetween.

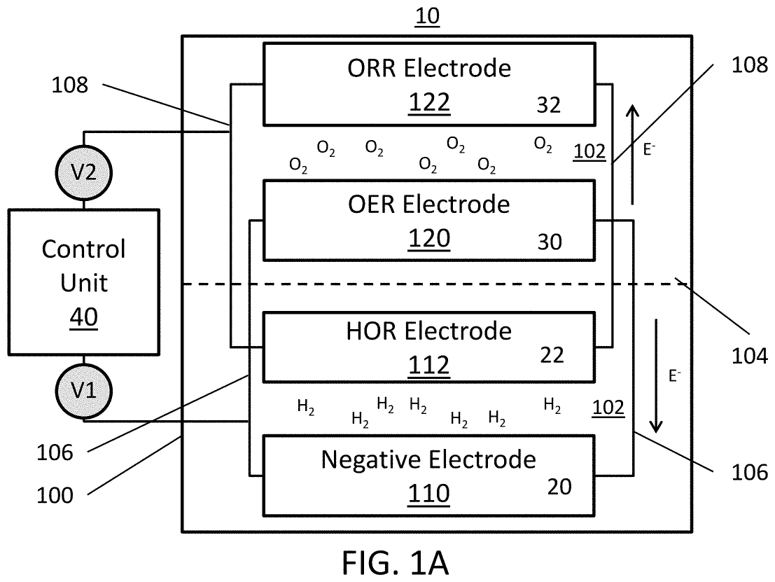

For example, FIG. 1A is a schematic view of an electrochemical system 10, according to various embodiments of the present disclosure, and FIG. 1B is a schematic view showing an electrical configuration of an electrochemical cell 100 of the system 10. Referring to FIGS. 1A and 1B, the system 10 may include a control unit 40 connected to one or more electrochemical cells 100. The electrochemical cell 100 may include a battery negative electrode 110, a hydrogen oxidation reaction (HOR) electrode 112, which may be referred to as an HOR cathode, a charging air oxygen evolution reaction (OER) electrode 120, which may be referred to as an OER cathode, and a discharging air oxygen reduction reaction (ORR) electrode 122, which may be referred to as an ORR cathode. The battery negative and HOR electrodes 110, 112 may be separated from the OER and ORR electrodes 120, 122 by a separator 104. The cell 100 may be configured to contain an alkaline electrolyte 102 (e.g., pH>11). In some embodiments, the electrolyte 102 may be comprised of water and one or more of the following hydroxide salts: lithium hydroxide, sodium hydroxide, potassium hydroxide.

The battery negative electrode 110 and the OER electrode 120 may be electrically connected to one another by a first circuit 106. The HOR and ORR electrodes 112, 120 may be electrically connected to one another by second circuit 108. A first terminal of the control unit 40 may be electrically connected to the first circuit 106 and a second terminal of the control unit 40 may be electrically connected to the second circuit 108.

In particular, the control unit 40 may be configured to control a fixed DC first voltage source V1 and a fixed DC second voltage source V2. The first voltage source V1 may be configured to apply a first voltage between the OER electrode 120 and the battery negative electrode 110. In addition, the second voltage source V2 may be configured to apply a second voltage between the ORR electrode 112 and the HOR electrode 110.

The battery negative electrode 110 may be formed of a metal, such as Fe, Zn, Al, Mg, and Cd. As a specific example, the iron (Fe) in the battery negative electrode 110 may be in the form of direct reduced iron (“DRI”), such as DRI pellets comprising at least about 60 wt % iron by elemental mass, based on the total mass of the pellets. As a further example, the DRI in the battery negative electrode 110 may comprise iron ore, direct reduced grade iron ore, reduced taconite, wustite, magnetite, hematite, cementite, iron oxide, or any combination thereof. As an additional example, the iron (Fe) in the battery negative electrode 110 may include a loose or sintered powder, such as sponge iron powder, atomized iron powder, or carbonyl iron powder. The battery negative electrode 110 may reversibly store and deliver electric charge. In certain embodiments, the battery negative electrode 110 may produce hydrogen gas (H₂) during the charging process, discharge process, and/or at rest. During charging of the cell 100, the battery negative electrode 110 may generate hydrogen gas (H₂) as a byproduct, according to the electrochemical reaction: 2H₂O+2e⁻→H_{2(g)}+2OH⁻_{(aq)}. In addition, when the battery negative electrode 110 includes Fe, the battery negative electrode 110 may self-discharge and generate hydrogen according to the following electrochemical reaction: Fe+2H₂O→Fe(OH)₂+H_{2(g)}.

The HOR electrode 122 may be arranged to capture hydrogen gas evolved from the battery negative electrode 110. The HOR electrode 112 may include a metal catalyst configured to catalyze the oxidation of the hydrogen gas through the following electrochemical reaction: H_{2(g)}+2OH⁻_{(aq)}→2H₂O+2e⁻. For example, the HOR electrode 112 may include a nickel (Ni) catalyst.

The OER electrode 120 may include a metal, such as Ni, Fe, or Co, or a metal oxide, such as CoO. The OER electrode 120 and/or the ORR electrode 122 may be air electrodes. During charging, oxygen gas (02) may be generated at the OER electrode 120. The ORR electrode 122 may be configured to reduce oxygen gas generated by the OER electrode 120, according to the following electrochemical reaction: O₂+2H₂O+4e⁻→4OH⁻.

Accordingly, when the electrochemical cell 100 is charging, hydrogen gas may be produced as an unwanted side reaction product at the battery negative electrode 110, and oxygen gas may be produced at the OER electrode 120. The HOR electrode 112 may be configured to collect and oxidize the hydrogen gas, and the ORR electrode 122 may be used to collect and reduce oxygen gas. The combination of the HOR and ORR electrodes 112, 122 operating in this fashion during charging produces a fuel cell structure within the cell 100, and this fuel cell structure can be used to generate energy from the hydrogen gas, which would otherwise be lost due to coulombic inefficiency. The four-electrode arrangement may operate to increase battery efficiency and reduce ventilation requirements for hydrogen safety management.

FIG. 1C illustrates how the implementation of an HOR electrode (e.g., HOR electrode 112) may be used to reduce the effective rate of self-discharge of a metal negative electrode. When the electrochemical cell is at rest, iron in the negative electrode of an iron-air or iron-MnO₂ battery can self-discharge through the following reaction: Fe+2H₂O→Fe(OH)₂+H_{2(g)}. Capturing and oxidizing of the hydrogen with an HOR electrode may generate electrons that may subsequently reduce the self-discharge reaction product (i.e., Fe(OH)₂). In one embodiment, hydrogen from self-discharge during an electrochemical rest is captured and fed into a hydrogen oxidation electrode, which converts the hydrogen gas into protons and electrons. These electrons are then used to reduce the self-discharged electrode. The self-discharge rate may increase with increasing operating temperature of the electrochemical device. In certain embodiments, a HOR electrode may enable the electrochemical device to operate at elevated temperatures with little to no increase in effective self-discharge rate. In certain embodiments, a HOR electrode may enable increasing the maximum operating temperature of the electrochemical cell. In some embodiments, the HOR electrode (e.g., HOR electrode 112) may be fully disposed within the electrolyte. For example, the HOR electrode may be submerged within the electrolyte along with other electrodes of the electrochemical cell. In some embodiments, the HOR electrode may be partially disposed within the electrolyte or the HOR electrode may outside the electrolyte. For example, the HOR electrode may be disposed within a headspace of the electrochemical cell.

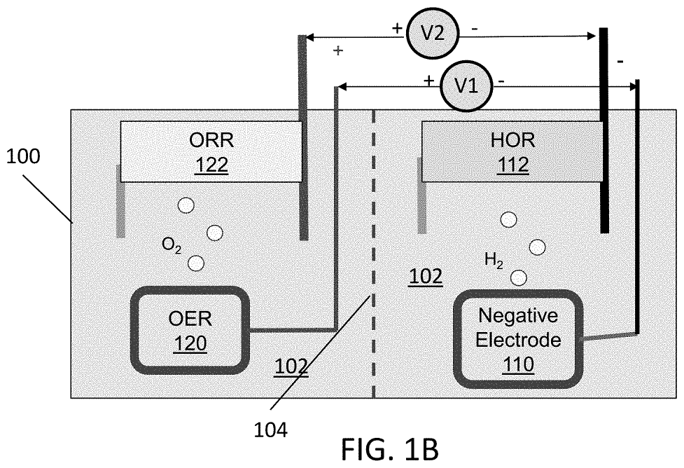

FIG. 2 is a schematic view showing an alternative electrical configuration of the electrochemical cell 190 in the system 10 of FIG. 1A. The electrochemical cell 190 is similar to electrochemical cell 100 described above, but provides a different electrical arrangement between the battery negative electrode 110, the OER electrode 120, and the HOR electrode 112. Referring to FIG. 2, a fixed DC first voltage source V1 may be configured to apply a first voltage between the OER electrode 120 and the battery negative electrode 110. In addition, a fixed DC second voltage source V2 may be configured to drive a second voltage between the HOR electrode 112 and the battery negative electrode 110.

Three-Electrode Electrochemical Cells

According to various embodiments of the present disclosure, provided are electrochemical cells having a three-electrode arrangement configured to oxidize hydrogen gas to recapture the electrons into a charging circuit. This charging circuit directs electrons to a battery negative electrode to store charge.

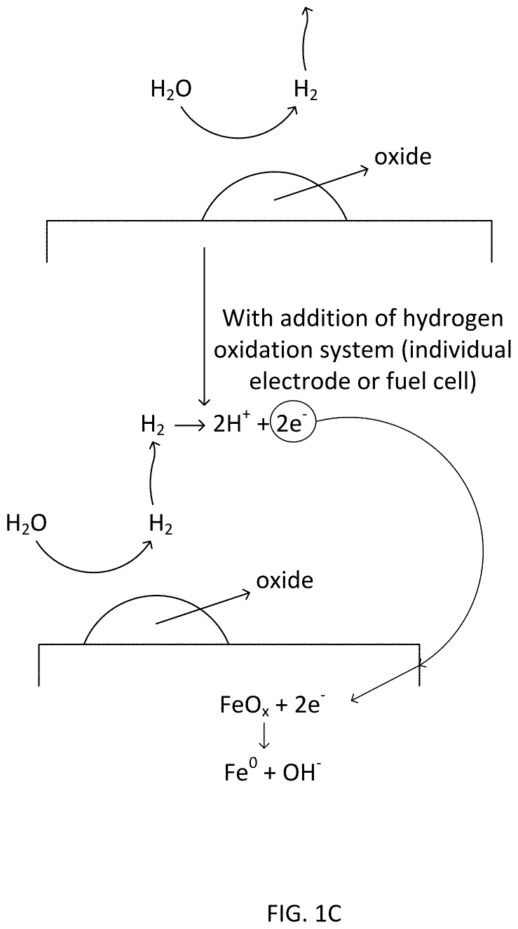

For example, FIG. 3A is a schematic view of an electrochemical cell 300 having a three-terminal configuration during discharging, according to various embodiments of the present disclosure, and FIG. 3B is a schematic view of the electrochemical cell 300 during charging. Referring to FIGS. 3A and 3B, the electrochemical cell 300 may include a battery negative electrode 310, a second electrode 320, and a third electrode 330. The battery negative electrode 310 may be formed of a metal, such as Fe, Zn, Al, Mg, and Cd, as described above with regard to the battery negative electrode 110.

The battery negative electrode 310 may be electrically connected to the second electrode 320 by a first circuit 340, and may be electrically connected to the third electrode 330 by a second circuit 342. The second and third electrodes 320, 330 may be electrically connected by a third circuit 344.

As shown in FIG. 3A, during discharge energy may be output from the battery negative electrode 310 to the third electrode 330, via the second circuit 342, and may be output from the second electrode 320 to the third electrode 330, through the third circuit 344. In addition, the second electrode 320 may operate as an HOR electrode, and the third electrode 330 may operate as an ORR electrode.

As shown in FIG. 3B, during charging, energy may be input to the battery negative electrode from the third electrode 330, via the second circuit 342, and may be input to the battery negative electrode 310 from the second electrode 320 to the battery negative electrode 310, via the first circuit 340. A voltage on the second circuit 342 may be less than a voltage on the first circuit 340. In addition, the second electrode 320 may operate as an OER electrode, and the third electrode 330 may operate as a HOR electrode.

The voltages, Va, Vb, Vc, Vd, Ve, and Vf shown in FIGS. 3A and 3B are exemplary voltages intended to show the relative magnitudes of the voltages applied to the electrodes 310, 320, 330, during charging and discharging. The voltages Va, Vb, Vc, Vd, Ve, and Vf may be various different values and the relationship of the voltages may be such that Va<Vb<Vc<Vd<Ve<Vf. For example, during discharging, a voltage of the battery negative electrode 310 may be less than a voltage of the second electrode 320, which may be less than a voltage of the third electrode 330. During charging, a voltage of the battery negative electrode 310 may be less than a voltage of the third electrode 330, which may be less than a voltage of the second electrode 320. As a specific example, when the electrochemical cell is iron based, the voltages Va, Vb, Vc, Vd, Ve, and Vf may be Va=about −0.5V, Vb=about −0.2V, Vc=about −0.1V, Vd=about 0.1V, Ve=about 0.8V, and Vf=about 1.5V.

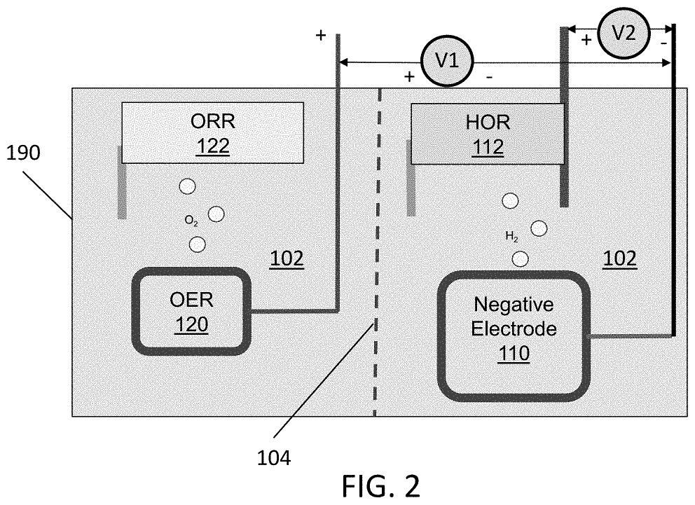

FIG. 4 is a schematic view of an embodiment three terminal configuration of an electrochemical cell 400 having a dual HOR/ORR electrode 422. The cell 400 may include a battery negative electrode 410 as described above that may evolve H₂ in a charge mode as illustrated in FIG. 4. The cell 400 may include an OER electrode 420. The cell 400 may include a fixed DC first voltage source V1 and a fixed DC second voltage source V2.

The first voltage source V1 may be configured to apply a first voltage between the battery negative electrode 410 and the OER electrode 420, along a first circuit 440. The second voltage source V2 may be configured to apply a second voltage between the battery negative electrode 410 and the HOR/ORR electrode 422 along a second circuit 442.

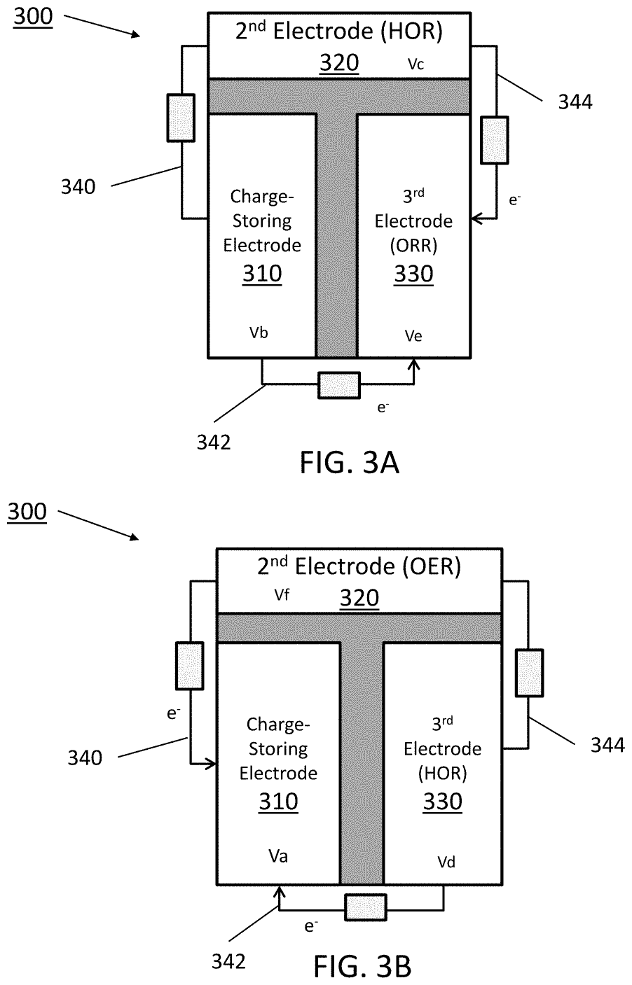

FIG. 5 is a schematic view of another embodiment three terminal configuration of an electrochemical cell 500. Cell 500 is similar to cell 400, except rather than a dual HOR/ORR electrode 422, the cell may include a separate ORR electrode 522 and OER electrode 520 and only one fixed voltage DC source V1 configured to apply a voltage between a battery negative electrode 510 and the OER electrode 520, along a first circuit 540. FIG. 5 illustrates the cell 500 in charging mode.

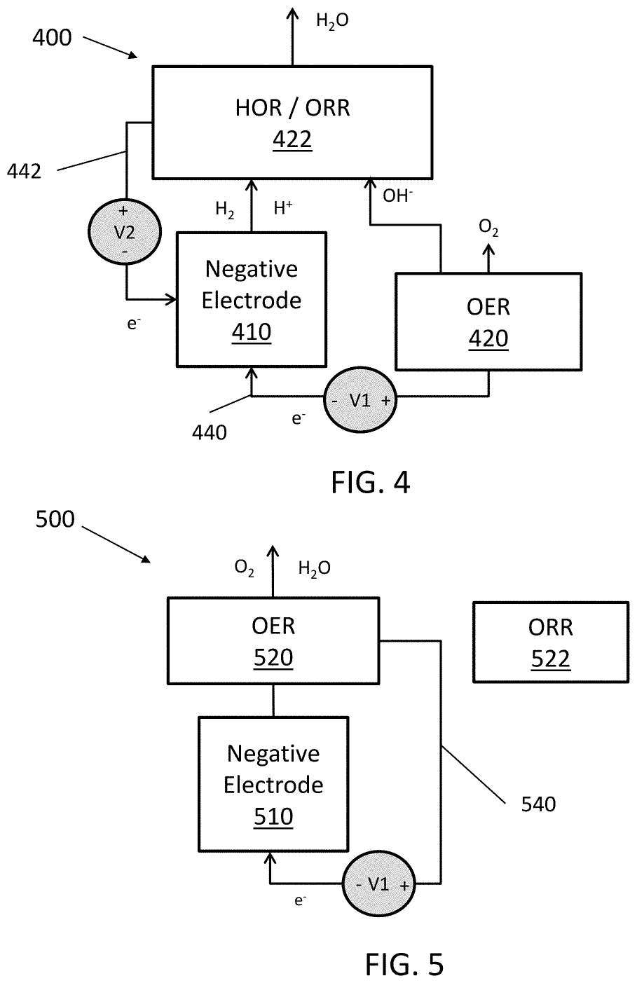

FIG. 6 is a schematic view of another embodiment three terminal configuration of an electrochemical cell 600. The cell 600 may include a battery negative electrode 610, an HOR electrode 612, and an OER electrode 620, as discussed above.

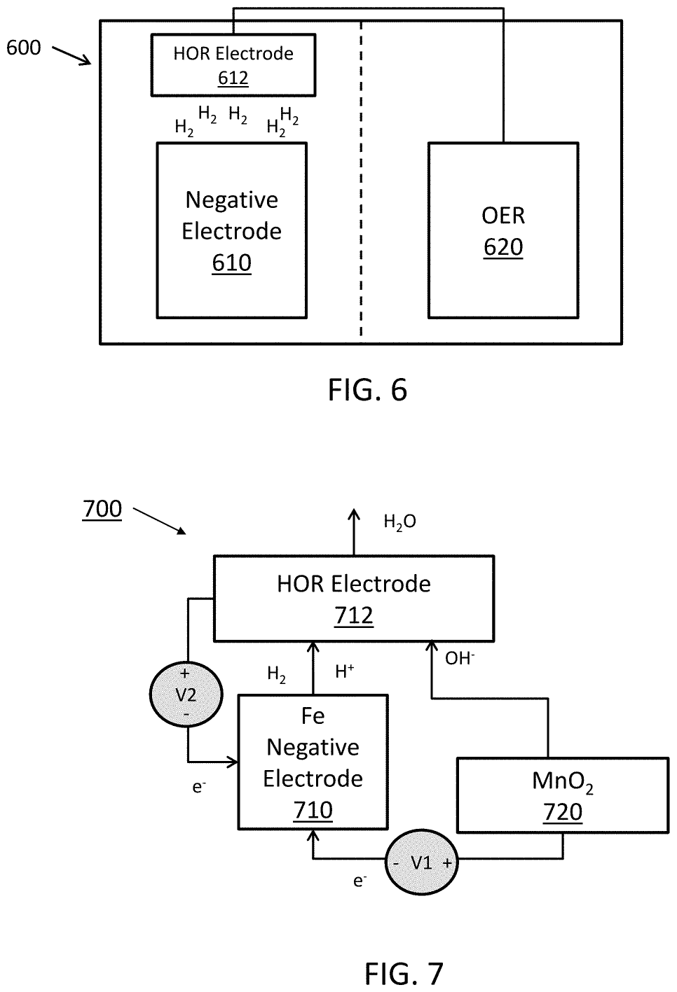

FIG. 7 is a schematic view of another embodiment three terminal configuration of an electrochemical cell 700. The cell 700 may include a battery negative electrode 710, an HOR electrode 712, and an OER electrode 720, as discussed above. The cell 700 may be a specific example of an iron (Fe) containing battery negative electrode 710 and a manganese dioxide (MnO₂) battery positive electrode 720 implemented with a HOR electrode 712.

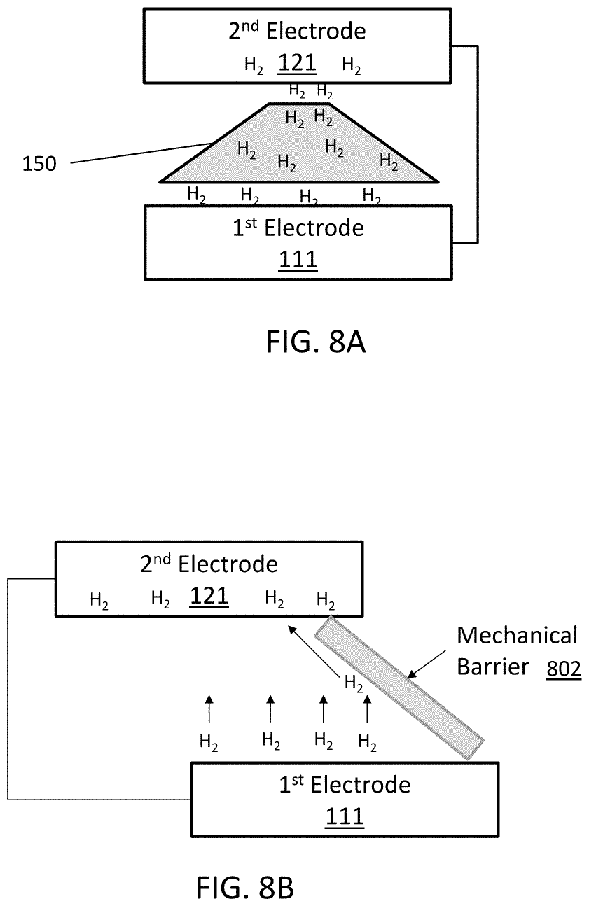

FIG. 8A is a schematic view showing a collection device 150 that may be included in an electrochemical cell, such as the electrochemical cells 100, 190, 300, 400, 500, 600, and/or 700 of FIGS. 1A-7, according to various embodiments of the present disclosure. Referring to FIG. 8, the collection device 150 may be disposed between a first electrode 111 (e.g., any electrode discussed with reference to FIGS. 1A-7 that may evolve hydrogen gas during operation) and a second electrode 121 of an electrochemical cell (e.g., any electrode discussed with reference to FIGS. 1A-7 that may operate as a HOR electrode). The collection device 150 may be a funnel-shaped component configured to collect gas generated at the first electrode 111, and provide the collected gas to the second electrode 121. In this manner, the collection device 150 may be configured to direct gas, such as hydrogen gas, to the second electrode 121. The collection device 150 may be comprised of non-conductive and chemically inert materials that may be included in an electrolyte, such as polypropylene, polyethylene, polytetrafluoroethylene, or polyvinylidene fluoride. FIG. 8B is a schematic view showing a collection device that may be a mechanical barrier 802, oriented at an angle between 0 and 90 degrees to the direction of hydrogen bubble generation, that directs the bubble flow to the second electrode 121, such as the HOR electrode. The mechanical barrier 802 may be included in an electrochemical cell, such as the electrochemical cells 100, 190, 300, 400, 500, 600, and/or 700 of FIGS. 1A-7.

For example, in some embodiments, the first electrode 111 may be a battery negative electrode and the second electrode 121 may be an HOR electrode. In this case, the collection device 150, 802 may be configured to collect hydrogen gas generated by the battery negative electrode, and provide the collected hydrogen gas to the HOR electrode. In this manner, hydrogen gas may be directed to the HOR electrode by the collection device 150, 802.

In other embodiments, the first electrode 111 may be an OER electrode and the second electrode 121 may be an ORR electrode. In this case, the collection device 150, 802 may be configured to collect oxygen emitted from the OER electrode and provide the collected oxygen gas to the ORR electrode.

Hydrogen Oxidation and Evolution Electrodes

Many of the traditional hydrogen evolution and/or oxidation catalysts are not fully optimized for use in alkaline conditions. Deployment in large scale alkaline electrochemical cells requires a cheap hydrogen oxidation electrode with high-stability and good performance in highly alkaline electrolyte solutions.

According to various embodiments of the present disclosure, oxidation catalysts paired with corresponding substrate materials are provided that enable the production of low-cost, large-format, HOR electrodes.

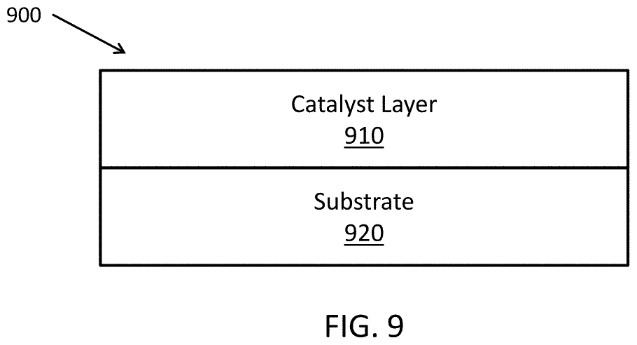

FIG. 9 is a schematic view of a catalyst electrode 900, such as a HOR electrode, according to various embodiments of the present disclosure. In various embodiments, the catalyst electrode 900 may be used as the HOR electrode of any of the electrochemical cells 100, 190, 300, 400, 500, 600, and/or 700 of FIGS. 1A-7 discussed above with reference to FIGS. 1A-8. Referring to FIG. 9, the catalyst electrode 900 may include a catalyst layer 910 disposed on a substrate 920. The catalyst layer 910 may include a metallic catalyst material represented by the following Formula 1:

M1ₓM2_{y}M3_{z} Formula 1

In Formula 1: x+y+z=1; M1 may comprise a transition metal such as Ni; M2 may comprise an electron donating transition metal such as Mo, Co, or combinations thereof; and M3 may comprises a different transition metal or metalloid, such as C, Cu, N, Si. Al, or combinations thereof.

The substrate 920 may include other materials of Formula 1 that include different ratios of the metals M1, M2, and M3, such as different ratios of x and y, x to z, and/or y and z, as compared to the catalyst layer 910. The substrate 920 may be in the form of a solid solution of multiple materials, an alloy of two materials, a compound of one or more components, or a single element substrate with high surface area and stability at all hydrogen potentials. In other embodiments, the substrate 920 may be formed of carbon paper, carbon felt, carbon cloth, carbon fiber, or the like.

In some embodiments, the catalyst layer 910 may include nickel nanoparticles supported on a carbon material, such as carbon nanotubes, graphite, activated carbon, graphene, reduced graphene oxide, or the like. For example, the catalyst layer 910 may include about 70% nickel nanoparticles and about 30 wt % carbon nanotubes. The carbon nanotubes may be surface-doped with 2.5 wt % nitrogen, in some embodiments.

In some embodiments, the catalyst layer 910 may include Ni_{5.1}Mo₁Co_{0.12}, which may be electro-deposited on the substrate 920.

In other embodiments, the catalyst layer 910 may include Raney nickel-derived catalysts including Ni, Al, and another transition metal (MT). For example, such catalysts may comprise a Ni:Al:MT ratio of about 49:49:2 wt %. The MT may be Fe, Cu, Ti, Cr, La, Mn, or combinations thereof. In some embodiments, MT may preferably comprise Cr, La, and/or Ti, in order to provide the highest catalytic performance.

In some embodiments, the substrate 920 may include a porous metal. In some embodiments, the porous metal may be comprised of sintered metal particles, a metal foam, metal wool, or metal fibers. In some embodiments, the substrate 920 may be comprised of a porous carbon. In some embodiments, the porous carbon may be comprised of a carbon felt, carbon paper, carbon particles, carbon cloth, or carbon fibers.

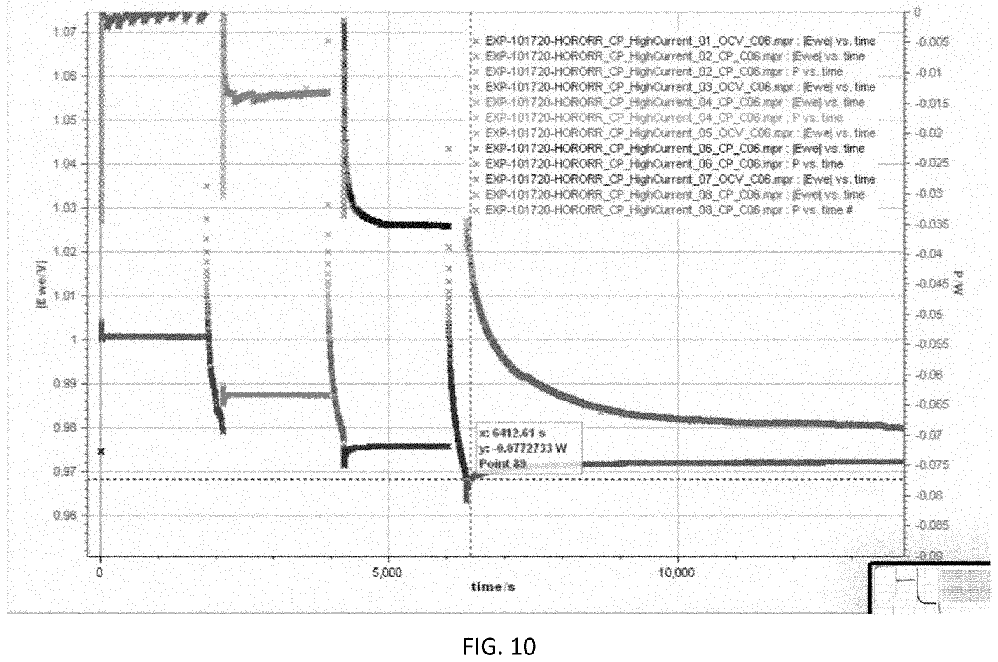

FIG. 10 is a graph showing hydrogen recombination power output vs. voltage applied to an HOR catalyst electrode, of a battery including a catalyst electrode according to various embodiments of the present disclosure. As shown in FIG. 10, as a voltage applied to the catalyst is pushed further from the HER equilibrium, the power output of the hydrogen recombination increases.

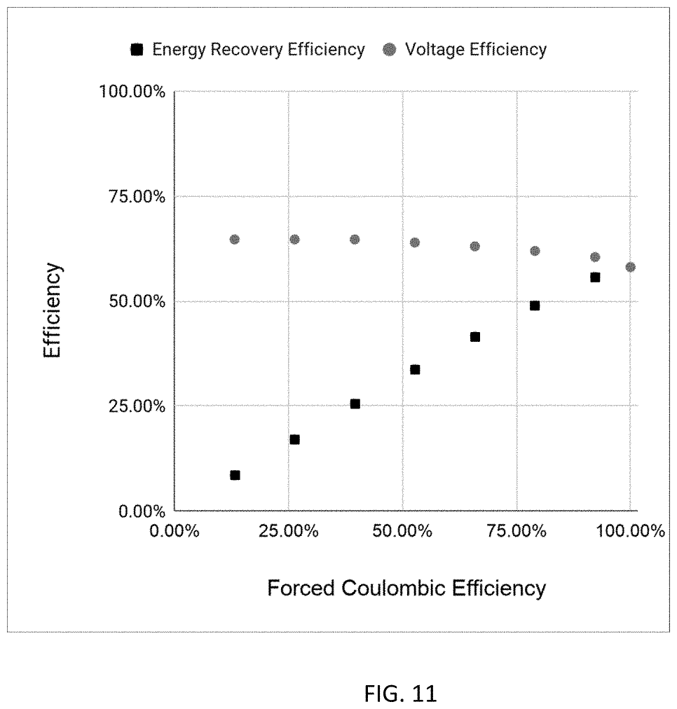

FIG. 11 is a graph showing energy recovery efficiency and voltage efficiency of a battery according to various embodiments of the present disclosure. As shown in FIG. 11, increasing the coulombic efficiency diminishes the voltage efficiency of the reaction to consume hydrogen.

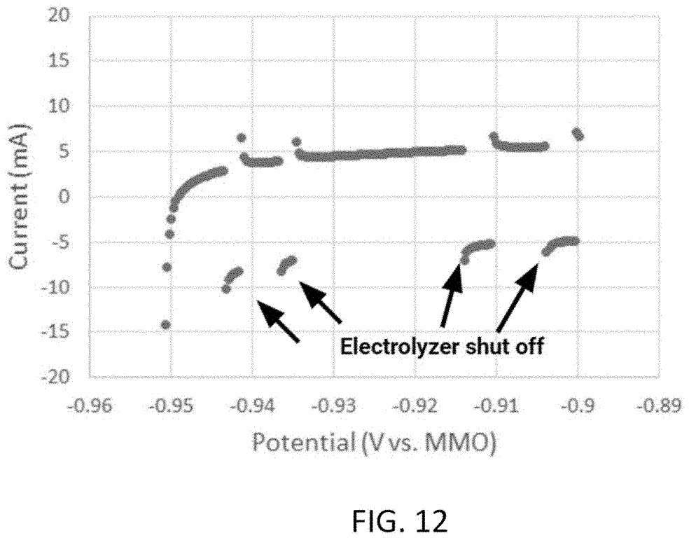

FIG. 12 is a graph showing cell potential vs. current of a battery according to various embodiments of the present disclosure. As shown in FIG. 12, a potential sweep of the HOR electrode vs. MMO is from −0.951 to −0.900 V. When the electrolyzer is shut off, the current reverses polarity. This demonstrates functionality of the HOR electrode in the presence of hydrogen gas.

Chemical Oxidation or Storage of Hydrogen

In various embodiments, noble metals, such as Pt, Pd, Au, or Ag, are the primary catalysts for the chemical oxidation of hydrogen. In some embodiments, the noble metal catalyst is mixed with an electronically conductive carbon, such as graphite, carbon black, or acetylene black, to increase the rate of hydrogen oxidation in the packed catalyst bed. In some embodiments, multiple metal catalysts are mixed to increase hydrogen oxidation rates. In some embodiments, the noble metal catalyst is alloyed with a transition metal, such as Ni, to increase the catalytic activity of the catalyst metal.

In various embodiments, manganese oxides (MnOx) are the primary catalysts for the chemical oxidation of hydrogen. In some embodiments, the MnOx species are MnO, Mn₃O₄, Mn₂O₃, MnOOH, MnO₂, or combinations thereof. In some embodiments, MnO₂ is alpha-, beta-, gamma-, delta-, lambda-, epsilon-MnO₂, or combinations thereof. In some embodiments. MnO₂ is natural MnO₂. In some embodiments, MnO₂ is electrolytic manganese dioxide (EMD). In some embodiments, MnOx is doped by transition metals, such as nickel, magnesium, cobalt, iron, or combinations thereof. In some embodiments, MnOx is mixed with a transition metal oxide (such as Bi₂O₃) or metal sulfide (such as Bi₂S₃), or combinations thereof. In some embodiments, the MnOx catalyst is mixed with an electronically conductive carbon, such as graphite, carbon black, or acetylene black, to increase the rate of hydrogen oxidation in the packed catalyst bed.

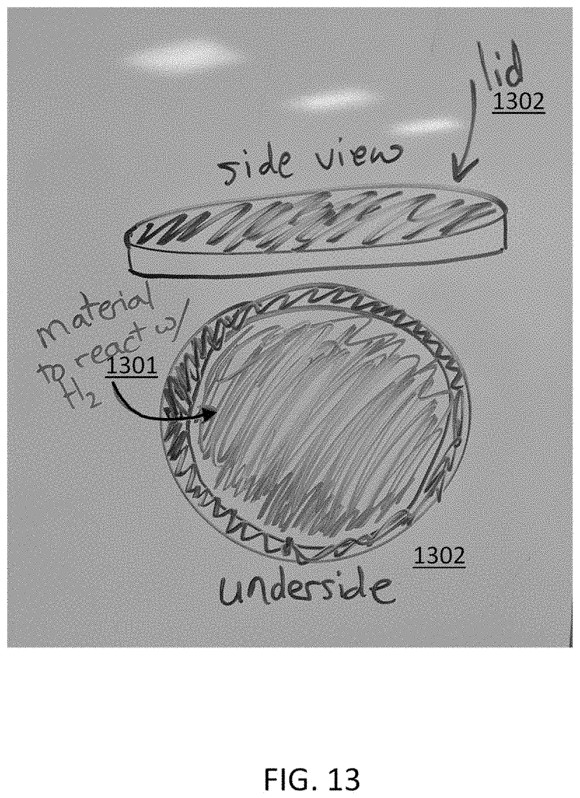

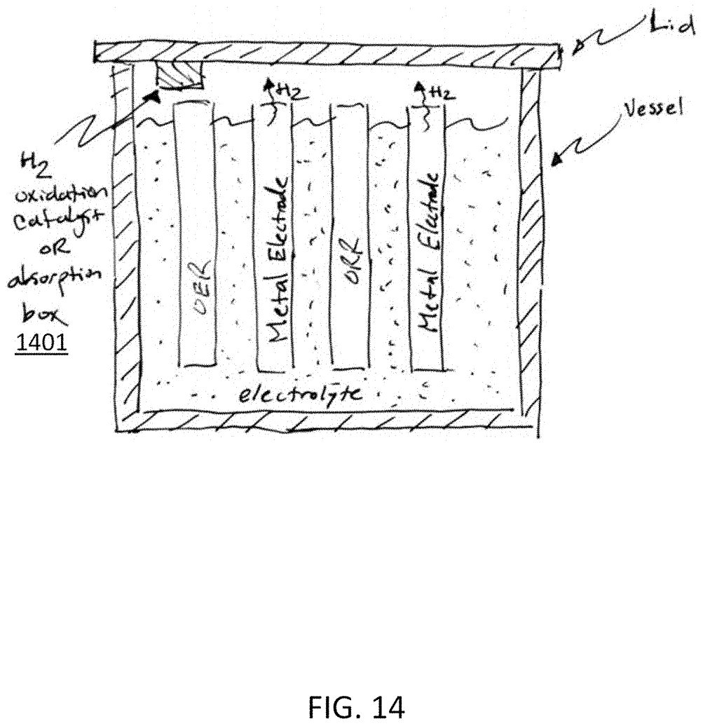

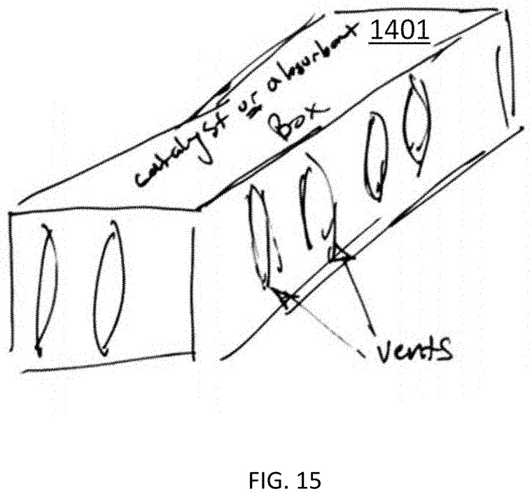

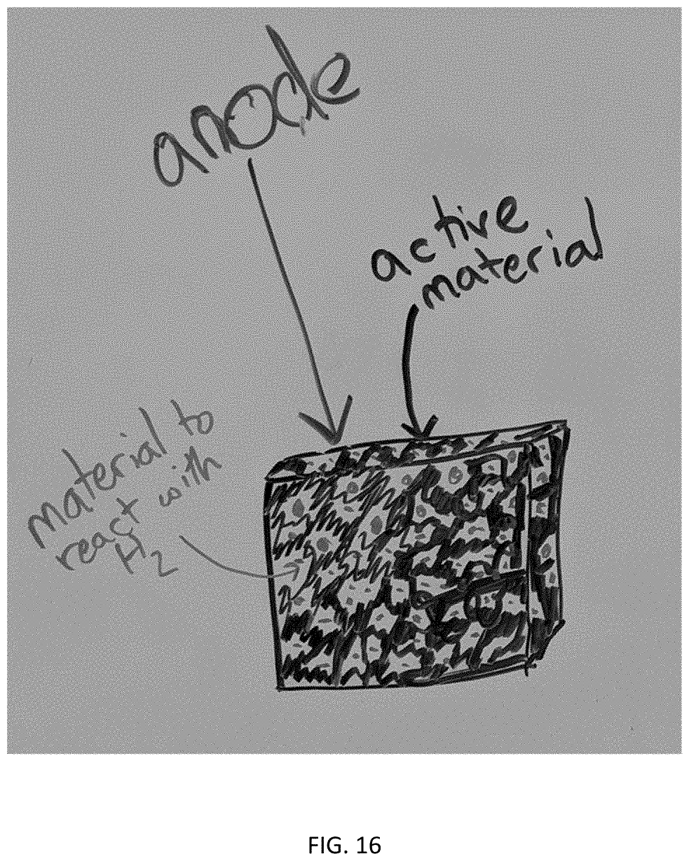

In various embodiments, the catalyst for the chemical oxidation of hydrogen may be coated or attached to an inside face of the mechanical housing or vessel of the electrochemical cell. FIG. 13 illustrates that, in some embodiments, the catalyst 1301 for the chemical oxidation of hydrogen may be coated on the inside of the lid or vertically oriented inner wall of the electrochemical cell. For example, the catalyst 1301 for the chemical oxidation of hydrogen may be coated on the inside of the lid and/or vertically oriented inner wall of an electrochemical cell, such as the electrochemical cells 100, 190, 300, 400, 500, 600, and/or 700 of FIGS. 1A-7. FIG. 13 shows a side view of the lid in the upper portion of the figure and the underside of the lid 1302 in the bottom portion. FIGS. 14-15 illustrate that, in some embodiments, the catalyst for the chemical oxidation of hydrogen may be contained in a box or cartridge 1401 containing vents that allows hydrogen gas to permeate to the absorption or storage material. For example, the box or cartridge 1401 including the catalyst may be suspended or otherwise inserted in an electrochemical cell, such as the electrochemical cells 100, 190, 300, 400, 500, 600, and/or 700 of FIGS. 1A-7. FIG. 16 illustrates that, in some embodiments, the hydrogen oxidation catalyst may be mixed with or impregnated into the metal anode of the electrochemical cell. For example, the hydrogen oxidation catalyst may be mixed with or impregnated into the metal anode of an electrochemical cell, such as the electrochemical cells 100, 190, 300, 400, 500, 600, and/or 700 of FIGS. 1A-7.

Various embodiments may provide chemical methods of absorbing or storing hydrogen. In some embodiments, the hydrogen absorption or storage material can be used to scavenge the hydrogen to mitigate safety challenges associated with free hydrogen gas.

In various embodiments, the hydrogen absorption or storage material is a metal hydride, such as MgH₂, NaAlH₄, LiAH₄, LiH, LaNi₅H₆, TiFeH₂, LiNH₂, LiBH₄, NaBH₄, ammonia borane, or palladium hydride. In some embodiments, the hydrogen absorption material is an organic molecule, such as N-ethylcarbazole.

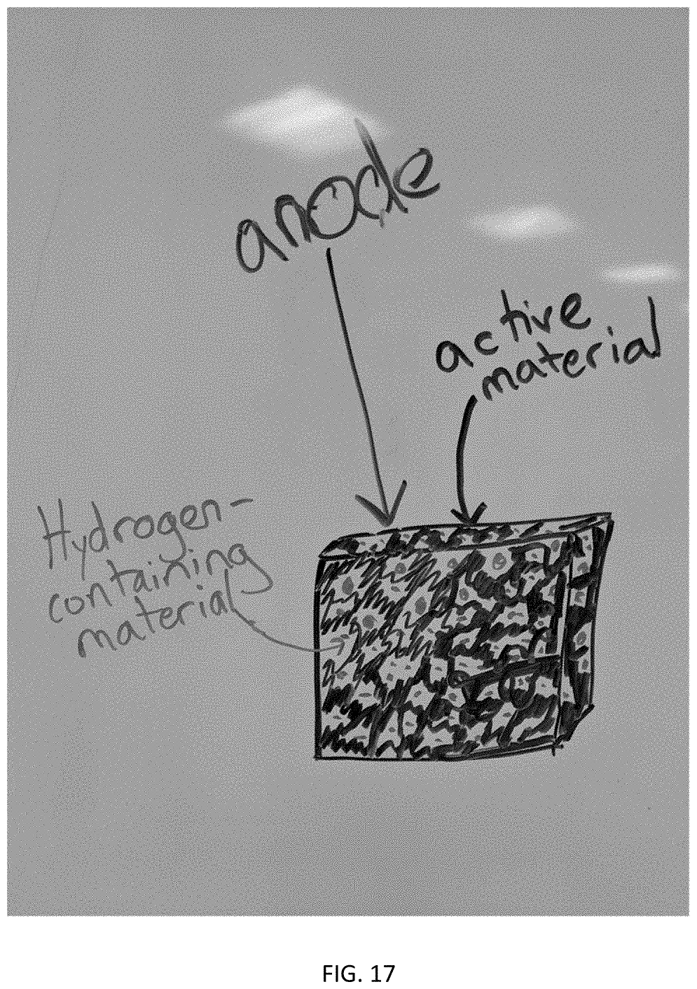

In various embodiments, the hydrogen absorption or storage material may be coated or attached to an inside face of the mechanical housing or vessel of the electrochemical cell. As an example, the hydrogen absorption or storage material may be coated or attached to an inside face of the mechanical housing or vessel of an electrochemical cell, such as the electrochemical cells 100, 190, 300, 400, 500, 600, and/or 700 of FIGS. 1A-7. In some embodiments, the hydrogen absorption or storage material may be coated on the inside of the lid or vertically oriented inner wall of the electrochemical cell. As an example, the hydrogen absorption or storage material may be coated on the inside of the lid or vertically oriented inner wall of an electrochemical cell, such as the electrochemical cells 100, 190, 300, 400, 500, 600, and/or 700 of FIGS. 1A-7. In some embodiments, the hydrogen absorption or storage material may be contained in a box or cartridge containing vents that allows hydrogen gas to permeate to the absorption or storage material. As an example, the hydrogen absorption or storage material may be contained in a box or cartridge containing vents that allows hydrogen gas to permeate to the absorption or storage material in an electrochemical cell, such as the electrochemical cells 100, 190, 300, 400, 500, 600, and/or 700 of FIGS. 1A-7. FIG. 17 illustrates that, in some embodiments, the hydrogen storage material may be mixed with or impregnated into the metal anode of the electrochemical cell. As an example, the hydrogen storage material may be mixed with or impregnated into the metal anode of an electrochemical cell, such as the electrochemical cells 100, 190, 300, 400, 500, 600, and/or 700 of FIGS. 1A-7. In some embodiments, the impregnated material may be material with high atomic or molecular hydrogen activity.

According to various embodiments, an electrochemical cell includes a negative electrode, a positive electrode, and an electrolyte. The negative electrode may be an iron material. The positive electrode may be a manganese oxide material. The electrolyte may be an aqueous solution. In certain embodiments the electrolyte may be an alkaline solution (pH>10). In certain embodiments, the electrolyte may be a near-neutral solution (10>pH>4)

According to various embodiments, the half-cell reactions on the negative electrode as occurring on discharge are:

Fe⁰⇄Fe²⁺+2e⁻

Fe²⁺⇄Fe³⁺+e⁻

In one example, half-cell reactions on the negative electrode as occurring on discharge are Fe+2OH⁻⇄Fe(OH)₂+2e⁻ and 3Fe(OH)₂+2OH⁻⇄Fe₃O₄+4H₂O+2e⁻. The theoretical capacity on the basis of metallic iron according to the negative electrode reactions in this example is 1276 mAh/g_{Fe}. During charge, the reversed reactions occur.

According to various embodiments, the possible half-cell reactions on the positive electrode as occurring on discharge are:

Mn⁴⁺(IV)+e⁻⇄Mn³⁺(III)

Mn³⁺(III)+e⁻⇄Mn²⁺(II)

In one example, half-cell reactions on the positive electrode as occurring on discharge are MnO₂+e⁻+H₂O⇄MnOOH+OH⁻ and MnOOH+e⁻+H₂O⇄Mn(OH)₂+OH⁻. The theoretical capacity on the basis of MnO₂ according to the negative electrode reactions in this example is 616 mAh/g_{MnO2}. During charge, the reversed reactions occur.

According to various embodiments, hydroxide anions (OH⁻) are the working ions. In some embodiments, both hydroxide anions and alkali metal cations are the working ions; in other words, the simultaneous migration of hydroxide anions and alkali metal cations along opposite directions carries the ionic current.

In some embodiments, the nominal cell voltage is about 1.1V if the predominant negative electrode reaction is between Fe⁰ and Fe²⁺ (Mechanism 1). In some embodiments, the nominal cell voltage is about 0.9V if the predominant negative electrode reaction is occurring between Fe²⁺ and Fe³⁺ (Mechanism 2). In certain embodiments, the nominal cell voltage is about 1.0V, or other values between 1.1V and 0.9V, when both Mechanisms 1 and 2 are occurring simultaneously or sequentially on the negative electrode.

According to various embodiments, the negative electrode is comprised of pelletized, briquetted, or pressed iron-bearing compounds. Such iron-bearing compounds may comprise one or more forms of iron, ranging from highly reduced (more metallic) iron to highly oxidized (more ionic) iron. In various embodiments, the pellets may include various iron compounds, such as iron oxides, hydroxides, sulfides, or combinations thereof. In various embodiments, the pellets may include one or more secondary phases, such as silica (SiO₂) or silicates, calcium oxide (CaO), magnesium oxide (MgO), etc. In various embodiments, said negative electrode may be sintered iron agglomerates with various different shapes. In various embodiments, sintered iron agglomerate pellets may be formed in a furnace, such as a continuous feed calcining furnace, batch feed calcining furnace, shaft furnace, rotary calciner, rotary hearth, etc. In various embodiments, pellets may comprise forms of reduced and/or sintered iron-bearing precursors known to those skilled in the art as direct reduced iron (DRI), and/or its byproduct materials. Various embodiments may include processing pellets, including DRI pellets, using mechanical, chemical, and/or thermal processes before introducing the pellets into the electrochemical cell.

The packing of pellets creates macro-pores, e.g., openings, spaces, channels, or voids, in between individual pellets. The macro-pores facilitate ion transport through electrodes that in some embodiments have a smallest dimension that is still very thick compared to some other types of battery electrodes, being multi-millimeter to multi-centimeter in the thickness dimension. The micro-pores within the pellets allow the high surface area active material of the pellet to be in contact with electrolyte to enable high utilization of the active material. This electrode structure lends itself specifically to improving the rate capability of extremely thick electrodes for stationary long duration energy storage, where thick electrodes may be required to achieve extremely high areal capacities (mAh/cm²).

The pellets for these embodiments, and in particular for use in embodiments of electrodes for long duration energy storage systems, can be any volumetric shape, e.g., spheres, discs, pucks, beads, tablets, pills, rings, lenses, disks, panels, cones, frustoconical shapes, square blocks, rectangular blocks, trusses, angles, channels, hollow sealed chambers, hollow spheres, blocks, sheets, films, particulates, beams, rods, angles, slabs, columns, fibers, staple fibers, tubes, cups, pipes, and combinations and various of these and other more complex shapes. The pellets in an electrode can be the same or different shapes. The pellets in an electrode that is one of several electrodes in a long duration energy storage system, can be the same as, or different from, the pellets in the other electrodes in that storage system.

The size of the pellets, unless expressly used otherwise, refers to the largest cross-sectional distance of the pellet, e.g., the diameter of sphere. The pellets can be the same or different sizes. It being recognized that the shape, size and both of the pellets, as well as, typically to a lesser degree the shape and size of the container or housing holding the pellets, determines the nature and size of the macro-pores in the electrode. The pellets can have sizes from about 0.1 mm to about 10 cm, about 5 mm to about 100 mm, 10 mm to about 50 mm, about 20 mm, about 25 mm, about 30 mm, greater than 0.1 mm, greater than 1 mm, greater than 5 mm, greater than 10 mm and greater than 25 mm, and combinations and variations of these.

In embodiments, the pellets as configured in an electrode can provide an electrode having a bulk density of from about 3 g/cm³ to about 6.5 g/cm³, about 0.1 g/cm³ to about 5.5 g/cm³, about 2.3 g/cm³ to about 3.5 g/cm³, 3.2 g/cm to about 4.9 g/cm³, greater than about 0.5 g/cm³, greater than about 1 g/cm³, greater than about 2 g/cm³, greater than about 3 g/cm³, and combinations and various of these as well as greater and lesser values.

In certain embodiments a mixture of reduced DR grade and reduced BF grade pellets may be used together. In certain other embodiments, reduced material (DRI) and raw ore materials (DR grade or BF grade) may be used in combination.

In various embodiments, DRI may be produced by the use of an “artificial ore” such as waste or by-product forms of iron oxide. As one non-limiting example, mill scale is a mixed iron oxide formed on the surface of hot rolled steel, which in various embodiments is collected and ground to form an iron oxide powder which is then agglomerated to form a pellet and is subsequently reduced to form DRI. Other waste streams may be similarly utilized to form DRI. As another non-limiting example, pickle liquor is an acidic solution which can be rich in dissolved Fe ions. In various embodiments, Fe-bearing pickle liquor may be neutralized with a base (such as caustic potash or sodium hydroxide) to precipitate iron oxide powder which is then agglomerated to form a pellet and is subsequently reduced to form DRI.

In various embodiments the precursor iron oxides are first reduced and then subsequently formed into a pellet or other agglomerate. In certain non-limiting embodiments iron oxide powder from a natural or artificial ore is reduced to iron metal powder by heat treatment at 900° C. under a reducing gas environment such as a linear hearth furnace with a hydrogen atmosphere, ranging from 1% to 100% H₂. In embodiments that use hydrogen as a reducing gas, the cementite (Fe₃C) content of the DRI can be as low as 0 wt %.

In various embodiments, DRI pellets or agglomerates are formed in a single process from iron oxide powders by use of a rotary calciner. The rotary motion of the furnace promotes agglomeration of the powder into a pellet or agglomerate, while the high temperature reducing gas environment provides for concurrent reduction of the iron oxide. In various other embodiments a multi-stage rotary calciner may be used in which the agglomerating and reducing steps may be tuned and optimized independently.

In various embodiments, the DRI has a shape that is not spherical. In certain embodiments the DRI may have a shape that is substantially rectilinear or brick-like. In certain embodiments the DRI may have a shape that is substantially cylindrical or rod-like, or disc-like. In certain embodiments the DRI may have a shape that is substantially planar or sheet-like. In certain embodiments the iron oxide powder is dry formed by die compaction into a cylindrical shape or any other shape that is amenable to die pressing. In certain embodiments the iron oxide powder is dry formed into a sheet-like form by roll pressing through a calendar roll. In certain embodiments the iron oxide powder is blended with a binder such as a clay or polymer and is dry processed into a rod-like shape by extrusion. In certain embodiments the iron oxide powder is blended with a binder such as a clay or polymer and is dry processed into a sheet-like form by roll pressing through a calendar roll. Binders may be comprised of a clay, such as bentonite, or a polymer, such as corn starch, polyacrylamide, or polyacrylate. Binders may be comprised of a combination of one or more clays and one or more polymers. In certain embodiments the iron oxide powder is dispersed into a liquid to form a slurry that is then used to wet form into various shapes. In certain embodiments an iron oxide slurry is slip cast into a mold of near-arbitrary shape. In certain embodiments an iron oxide slurry is coated onto a sheet by doctor blading or other similar coating processes.

In various embodiments, a bed of conductive micro-porous pellets comprise an electrode in an energy storage system. In some embodiments, said pellets comprise pellets of direct reduced iron (DRI). The packing of pellets creates macro-pores in between individual pellets. The macro-pores facilitate ion transport through electrodes that in some embodiments have a smallest dimension that is still very thick as compared to some other types of battery electrodes, being of multiple centimeters in dimension. The macropores may form a pore space of low tortuosity compared to the micro-pores within the pellets. The micro-pores within the pellets allow the high surface area active material of the pellet to be in contact with electrolyte to enable high utilization of the active material. This electrode structure lends itself specifically to improving the rate capability of extremely thick electrodes for stationary long duration energy storage, where thick electrodes may be required to achieve extremely high areal capacities.

In various embodiments, a fugitive pore former is incorporated during the production of DRI to increase the porosity of the resulting DRI. In one embodiment, the porosity of the DRI pellet is modified by incorporating a sacrificial pore former such as ice (solid H₂O) in the pelletization process, which subsequently melts or sublimes away under thermal treatment. In certain other embodiments the fugitive pore former comprises napthalene, which subsequently sublimes to leave porosity. In other embodiments the fugitive pore former comprises NH₄CO₃ (ammonium carbonate) may be the fugitive pore former, and it may be introduced as a solid at various points in the production of DRI and will decompose under heat and leave entirely as gaseous or liquid species (NH₃+CO₂+H₂O). In various other embodiments, the fugitive additive may serve an additional function in the cell (e.g. be an electrolyte component). In certain embodiments the fugitive additive may be an alkaline salt such as KOH or NaOH or LiOH. In certain embodiments the fugitive additive may be a soluble electrolyte additive which is solid in form under ambient, dry conditions, such as lead sulfate, lead acetate, antimony sulfate, antimony acetate, sodium molybdenum oxide, potassium molybdenum oxide, thiourea, sodium stannate, ammonium thiosulfate. In various other embodiments the fugitive additive may be a binder used in the agglomeration of iron ore powder to form a pellet or other shape, such as sodium alginate or carboxymethylcellulose binder.

In certain embodiments, the reducing gas used to form DRI is hydrogen (H₂). In certain embodiments, the hydrogen is generated by electrolysis of water from renewable power generation sources such as wind energy or solar energy. In certain embodiments the electrolyzer is coupled to an energy storage system. In certain embodiments the electrolyzer is a Proton Exchange Membrane (PEM) electrolyzer. In certain embodiments the electrolyzer is an alkaline electrolyzer. In embodiments that use hydrogen as a reducing gas, the cementite (Fe₃C) content of the DRI can be as low as 0 wt.

In certain embodiments, natural gas (methane, CH₄) is used as a reducing agent to produce DRI. In certain embodiments, the methane is steam reformed (via reaction with water, H₂O) to produce a mixture of carbon monoxide (CO) and hydrogen (H₂) through the reaction CH₄+H₂O→CO+3H₂. In certain embodiments, this reforming reaction occurs through an ancillary reformer, separate from the reactor in which the iron reduction occurs. In certain embodiments, the reforming occurs in situ in the reduction reactor. In certain embodiments the reforming occurs both in an ancillary reformer and in the reduction reactor. In certain embodiments, coal is used as a reducing agent to produce DRI. In certain embodiments coke is used as a reducing agent to produce DRI. In embodiments that use a carbon-containing reducing gas, the cementite (Fe₃C) content of the DRI can be higher, up to 80 wt %.

In certain embodiments, a mixture of DRI produced using various reducing gases can be used to achieve a beneficial combination of composition and properties. In one non-limiting embodiment a 50/50 mix by mass of DRI produced from BF grade pellets reduced in natural gas and DRI produced from DR grade pellets reduced in hydrogen is used as the negative electrode of a battery. Other combinations of mass ratios, feedstock type (DR, BE other artificial ores, etc.) and reducing media (hydrogen, natural gas, coal, etc.) may be combined in other embodiments.

In various embodiments, DRI pellets may be crushed and the crushed pellets may comprise the bed (with or without the addition of a powder).

In various embodiments, additives beneficial to electrochemical cycling, for instance, Hydrogen Evolution Reaction (HER) suppressants may be added to the bed in solid form, for instance, as a powder, or as solid pellets.

In some embodiments, metal electrodes may have a low initial specific surface area (e.g., less than about 5 m²/g and preferably less than about 1 m²/g). Such electrodes tend to have low self-discharge rates in low-rate, long duration energy storage systems. One example of a low specific surface area metal electrode is a bed of DRI pellets. In many typical, modern electrochemical cells, such as lithium ion batteries or nickel-metal-hydride batteries, a high specific surface area is desirable to promote high rate capability (i.e., high power). In long duration systems, the rate capability requirement is significantly reduced, so low specific surface area electrodes can meet target rate-capability requirements while minimizing the rate of self-discharge.

In some embodiments. DRI pellets are processed by mechanical, chemical, electrical, electrochemical, and/or thermal methods before the DRI pellets are used in an electrochemical cell. Such pre-treatments may allow superior chemical and physical properties to be achieved, and, for example, may increase the accessible capacity during the discharge reaction. The physical and chemical properties of as-purchased (also sometimes referred to as “as received”) DRI may not be optimal for use as the negative electrode of an electrochemical cell. Improved chemical and physical properties may include introduction of a higher content of desirable impurities, such as HER suppressants, achieving a lower content of undesirable impurities (such as HER catalysts), achieving a higher specific surface area, achieving a higher total porosity, achieving a different pore size distribution from the starting DRI (such as a multimodal pore size distribution to reduce mass transport resistance), achieving a desired distribution of pellet sizes (such as a multimodal size distribution to allow packing of pellets to a desired density), altering or selecting pellets of a desired aspect ratio (in order to achieve a desired bed packing density). Mechanical processing may include tumbling, milling, crushing, pulverizing, and powderizing. Chemical processing may include acid etching. Chemical processing may include soaking a bed of pellets in an alkaline solution to create necking between pellets as well as coarsening of the micropores within the pellets. Thermal processing may include processing DRI in at elevated temperature in inert, reducing, oxidizing, and/or carburizing atmosphere. In various embodiments, mechanical, chemical, electrical, electrochemical, and/or thermal methods of pre-processing the materials forming an electrode, such as DRI pellets, etc., may fuse the material forming the electrode into a bed, such as bed of fused together DRI pellets, etc.

In some embodiments, the negative electrode may contain inert conductive matrix including carbon black, graphite powder, carbon steel mesh, stainless steel mesh, steel wool, nickel-coated carbon steel mesh, nickel-coated stainless steel mesh, nickel-coated steel wool, or combinations thereof.

According to various embodiments, the positive electrode is comprised of manganese-bearing compounds, including manganese (IV) oxide (MnO₂), manganese (III) oxide (Mn₂O₃), manganese (III) oxyhydroxide (MnOOH), manganese (II) oxide (MnO), manganese (II) hydroxide (Mn(OH)₂), or combinations thereof. In some embodiments, the positive electrode may contain one or more natural oxide minerals of manganese such as birnessite, pyrolusite, hausmannite, akhtenskite, hollandite, ramsdellite, nsutite, spinel, psilomelane, todorokite, bixbyite, or combinations thereof. In some embodiments, the positive electrode may contain manganese-bearing compounds with the structure of oxide mineral of manganese such as birnessite, etc. In some embodiments, the positive electrode may contain electrolytic manganese dioxide (EMD). In some embodiments, the manganese dioxide is in the phase of α-MnO₂, β-MnO₂, γ-MnO₂, δ-MnO₂, ε-MnO₂, λ-MnO₂, or combinations thereof. In some embodiments, the positive electrode may contain manganese (II) hydroxide (Mn(OH)₂). In some embodiments, the positive electrode may contain hydroxide mineral of manganese such as pyrochroite. In some embodiments, the positive electrode may contain manganese-bearing compounds with the structure of hydroxide mineral of manganese such as pyrochroite. In some embodiments, the positive electrode may contain manganese (III) oxyhydroxide (MnOOH). In some embodiments, the positive electrode may contain oxyhydroxide mineral of manganese such as manganite. In some embodiments, the positive electrode may contain manganese-bearing compounds with the structure of oxyhydroxide mineral of manganese such as manganite. In various embodiments, the positive electrode includes inert conductive matrix including carbon black, graphite powder, charcoal powder, coal powder, nickel-coated carbon steel mesh, nickel-coated stainless steel mesh, nickel-coated steel wool, or combinations thereof.

In some embodiments, the positive electrode may contain additive(s) to enhance the capacity and cyclability of the positive electrode. In some embodiments, the additive in the positive electrode includes bismuth (III) oxide (Bi₂O₃), bismuth (III) sulfide (Bi₂S₃), barium oxide (BaO), barium sulfate (BaSO₄), barium hydroxide (Ba(OH)₂), calcium oxide (CaO), calcium sulfate (CaSO₄), calcium hydroxide (Ca(OH)₂), magnesium oxide (MgO), magnesium hydroxide (Mg(OH)₂), carbon nanotubes, carbon nanofibers, graphene, or combinations thereof.

In some embodiments, the positive electrode may contain binder compound(s). In some embodiments, the binder compound includes polytetrafluoroethylene (PTFE), polyvinylidene difluoride (PVdF), polypropylene (PP), polyethylene (PE), polyacrylonitrile, styrene butadiene rubber, sodium carboxymethyl cellulose (Na-CMC), or combinations thereof.

In various embodiments, the loading of manganese-bearing compound(s) in the positive electrode is in the range of 50 and 90 weight percent on the basis of the equivalent mass of MnO₂. In various embodiments, the loading of conductive matrix in the positive electrode is in the range of 5 and 30 weight percent. In various embodiments, the loading of additive(s) in the positive electrode is in the range of 0 and 20 weight percent. In various embodiments, the loading of binder in the positive electrode is in the range of 0 and 10 weight percent. In some embodiments, the manganese-bearing compound(s) and additive(s) are mixed through chemical reactions or physical process(es) such as milling, or combinations thereof.

In various embodiments, electrolyte is comprised of aqueous alkali metal hydroxide including lithium hydroxide (LiOH), sodium hydroxide (NaOH), potassium hydroxide (KOH), cesium hydroxide (CsOH), or combinations thereof. In some embodiments, electrolyte may contain alkali metal sulfide or polysulfide including lithium sulfide (Li₂S) or polysulfide (Li₂Sₓ, x=2 to 6), sodium sulfide (Na₂S) or polysulfide (Na₂Sₓ, x=2 to 6), potassium sulfide (K₂S) or polysulfide (K₂Sₓ, x=2 to 6), cesium sulfide (Cs₂S) or polysulfide (Cs₂Sₓ, x=2 to 6). In some embodiments, electrolyte may contain hydrogen evolution reaction (HER) suppressor. In some embodiments, the HER suppressors can be selected from the non-limiting set of sodium thiosulfate, sodium thiocyanate, polyethylene glycol (PEG) 1000, trimethylsulfoxonium iodide, zincate (by dissolving ZnO in NaOH), hexanethiol, decanethiol, sodium chloride, sodium permanganate, lead (IV) oxide, lead (II) oxide, magnesium oxide, sodium chlorate, sodium nitrate, sodium acetate, iron phosphate, phosphoric acid, sodium phosphate, ammonium sulfate, ammonium thiosulfate, lithopone, magnesium sulfate, iron(III) acetylacetonate, hydroquinone monomethyl ether, sodium metavanadate, sodium chromate, glutaric acid, dimethyl phthalate, methyl methacrylate, methyl pentynol, adipic acid, allyl urea, citric acid, thiomalic acid. N-(2-aminoethyl)-3-aminopropyl trimethoxysilane, propylene glycol, trimethoxysilyl propyl diethylene, aminopropyl trimethoxysilane, dimethyl acetylenedicarboxylate (DMAD), 1,3-diethylthiourea, N,N′-diethylthiourea, aminomethyl propanol, methyl butynol, amino modified organosilane, succinic acid, isopropanolamine, phenoxyethanol, dipropylene glycol, benzoic acid, N-(2-aminoethyl)-3-aminopropyl, behenamide, 2-phosphonobutane tricarboxylic, mipa borate 3-methacryloxypropyltrimethoxysilane, 2-ethylhexoic acid, isobutyl alcohol, t-butylaminoethyl methacrylate, diisopropanolamine, propylene glycol n-propyl ether, sodium benzotriazolate, pentasodium aminotrimethylene phosphonate, sodium cocoyl sarcosinate, laurylpyridinium chloride, steartrimonium chloride, stearalkonium chloride, calcium montanate, quaternium-18 chloride, sodium hexametaphosphate, dicyclohexylamine nitrite, lead stearate, calcium dinonylnaphthalene sulfonate, iron(II) sulfide, sodium bisulfide, pyrite, sodium nitrite, complex alkyl phosphate ester (e.g. RHODAFAC® RA 600 Emulsifier), 4-mercaptobenzioc acid, ethylenediaminetetraacetic acid, ethylenediaminetetraacetate (EDTA), 1,3-propylenediaminetetraacetate (PDTA), nitrilotriacetate (NTA), ethylenediaminedisuccinate (EDDS), diethylenetriaminepentaacetate (DTPA), and other aminopolycarboxylates (APCs), diethylenetriaminepentaacetic acid, 2-methylbenzenethiol, 1-octanethiol, bismuth sulfide, bismuth oxide, antimony(III) sulfide, antimony(III) oxide, antimony(V) oxide, bismuth selenide, antimony selenide, selenium sulfide, selenium(IV) oxide, propargyl alcohol, 5-hexyn-1-ol, 1-hexyn-3-ol, N-allylthiourea, thiourea, 4-methylcatechol, trans-cinnamaldehyde. Iron(III) sulfide, calcium nitrate, hydroxylamines, benzotriazole, furfurylamine, quinoline, tin(II) chloride, ascorbic acid, tetraethylammonium Hydroxide, calcium carbonate, magnesium carbonate, antimony dialkylphosphorodithioate, potassium stannate, sodium stannate, tannic acid, gelatin, saponin, agar, 8-hydroxyquinoline, bismuth stannate, potassium gluconate, lithium molybdenum oxide, potassium molybdenum oxide, hydrotreated light petroleum oil, heavy naphthenic petroleum oil (e.g. sold as Rustlick® 631), antimony sulfate, antimony acetate, bismuth acetate, hydrogen-treated heavy naphtha (e.g. sold as WD-40@), tetramethylammonium hydroxide, NaSb tartrate, urea, D-glucose, C₆Na₂O₆, antimony potassium tartrate, hydrazinsulphate, silica gel, triethylamine, potassium antimonate trihydrate, sodium hydroxide, 1,3-di-o-tolyl-2-thiourea, 1,2-diethyl-2-thiourea, 1,2-diisopropyl-2-thiourea, N-phenylthiourea, N,N′-diphenylthiourea, sodium antimonyl L-tartrate, rhodizonic acid disodium salt, sodium selenide, and combinations thereof.

In various embodiments, a separator that is impermeable to electrons and permeable to at least one alkali metal ion or the hydroxide ion is in close contact between the negative electrode and the positive electrode. In some embodiments, a separator is non-woven fiber layer including nylon, cellulose, etc. In some embodiments, a separator is a porous polymer layer including polypropylene separator, polyethylene separator, and polybenzimidazole separator. In some embodiments, a separator is a woven layer including polypropylene mesh, polyethylene mesh, polyester mesh, and cotton gauze. In some embodiments, an anion-exchange membrane that selectively conducts hydroxide ion is in close contact between the negative electrode and the positive electrode.

In various embodiments, battery components are assembled in prismatic configuration or cylindrical configuration. In various embodiments, current collector includes nickel, stainless steel, nickel-coated stainless steel, nickel-coated carbon steel, and nickel coated steel wool, or combinations thereof. In various embodiments, current collector is plate or mesh. In various embodiments, battery housing materials are polypropylene or high-density polyethylene. In various embodiments, electrolyte is in static (non-circulating) mode or flowing (circulating) mode.

In various embodiments, the cell or stack is charged in a current controlled, voltage controlled, or power controlled mode, or combinations thereof. In various embodiments, the cell or stack is charged in constant current, constant voltage, constant power mode, or combinations thereof. In various embodiments, the cell or stack is discharged in constant current, constant voltage, constant power mode, or combinations thereof. In various embodiments, the cell or stack is discharged in a current controlled, voltage controlled, or power controlled mode, or combinations thereof.

In various embodiments, the operating temperature is in the range of −20° Celsius to 60° Celsius. In some embodiments, the preferred operating temperature is in the range of 20° Celsius to 40° Celsius.

In another non-limiting example, pelletized direct reduced iron (DRI) is used as the negative electrode. In some embodiments, the electrochemical cell using DRI as the negative electrode and the manganese oxide based positive electrode is in prismatic cell configuration or stacked prismatic cell configuration. In some embodiments, the electrochemical cell using DRI as the negative electrode and the manganese oxide based positive electrode is in cylindrical cell configuration.

In another non-limiting example, the manganese-bearing compound in the positive electrode is 6-MnO₂ (birnessite) with layered crystal structure. The interlayer of δ-MnO₂ may contain metal cations. The metal cations are Li+, Na+, K+, Mg2+, Ca2+, Ba2+, Cu2+, Fe²⁺, Fe³⁺, Bi³⁺, Pb²⁺, Zn²⁺, or combinations thereof. The interlayer of δ-MnO₂ may contain protons. The interlayer of δ-MnO₂ may contain water molecules. In some embodiments, δ-MnO₂ is chemically produced from water soluble manganese precursors such as NaMnO4, KMnO₄, MnSO₄, MnCl₂, Mn(NO₃)₂, Mn (II) acetate, or combinations thereof, prior to cell assembly. In certain embodiments, δ-MnO₂ is produced by mixing stoichiometric amount of NaMnO₄ and MnSO₄ aqueous solutions in the presence of 1 mol/L KCl, followed by heat treatment of the mixed solutions at 90° Celsius for 1 hour. In some embodiments, δ-MnO₂ is electrochemically produced after cell assembly using MnO₂ in other phases. In some embodiments, δ-MnO₂ is produced in situ during the first charge/discharge cycle. In some embodiments, δ-MnO₂ is produced in situ during the first a few charge/discharge cycles. MnO₂ in other phases includes natural MnO₂ (β-MnO₂), electrolytic manganese oxide (EMD, γ-MnO₂, ε-MnO₂), or combinations thereof.

In another non-limiting example, MnO₂ powder and Bi₂O₃ powder are physically mixed and milled in the presence of graphite. According to various embodiments, MnO₂ powder is natural MnO₂, EMD, birnessite, or combinations thereof. In certain embodiments, PTFE as the binder is added in the powder mixture before milling. The milled powder mixture is used as the positive electrode in an assembled cell. In some embodiments, the assembled cell is in full-cell configuration using DRI negative electrode. In some embodiments, the assembled cell is in half-cell configuration using nickel counter electrode. In some embodiments, the Bi-doped MnO₂ is produced through constant current cycling. In some embodiments, the cut-off potential during the reducing process is <−0.4V vs. mercury/mercury oxide (MMO) reference electrode. In certain embodiments, the cut-off potential during the reducing process is between −0.5V and −0.7V vs. MMO reference electrode. In some embodiments, the cut-off potential during the oxidizing process is >−0.3V vs. MMO reference electrode. In certain embodiments, the cut-off potential during the reducing process is between 0.1V and 0.3V vs. MMO. In some embodiments, the charge/discharge rate is between C/24 and C/1. In certain embodiments, the charge/discharge cycle number is 1. In some embodiments, the Bi-doped MnO₂ is produced through constant potential cycling. In some embodiments the reducing potential is <−0.5V vs. MMO reference electrode and the oxidizing potential is >0.1V vs. MMO reference electrode. In some embodiments, the Bi-doped MnO₂ is produced through constant power cycling. In some embodiments, the Bi-doped MnO₂ is produced through cyclic voltammetry. In certain embodiments, the upper potential of cyclic voltammetry is between 0.1V and 0.3V vs. MMO reference electrode. In certain embodiments, the lower potential of cyclic voltammetry is between −0.5V and −0.7V vs. MMO reference electrode. In some embodiments, the scan rate <100 mV/s. In certain embodiments, the scan rate is between 0.1 mV/s and 1.0 mV/s. In some embodiments, the cycle number is <100. In certain embodiments, the cycle number is <10.

In another non-limiting example, an electrochemical cell with a nominal discharge duration of 1 hour with the rated current density at 15 mA/cm2 and rated cell voltage at 0.79V. was built based on the proposed electrode reactions. MnO₂ powder and Bi₂O₃ powder are physically mixed and milled in the presence of graphite. According to various embodiments, MnO₂ powder is natural MnO₂. EMD, birnessite, or combinations thereof. In certain embodiments. PTFE as the binder is added in the powder mixture before milling. In certain embodiments, 30 wt % KOH solution is added in the powder mixture before milling. In certain embodiments, the MnO₂ loading in the positive electrode is 65 wt %. The milled manganese containing powder mixture is used as the positive electrode in an assembled cell. Iron-bearing powder and Bi₂S₃ powder are physically mixed and milled in the presence of graphite. In some embodiments, iron-bearing powder is metallic iron such as DRI fines, smashed DRI, or combinations thereof. In some embodiments, iron-bearing powder is iron compound such as Fe(OH)2, Fe2O3, Fe3O4, or combinations thereof. In certain embodiments, PTFE as the binder is added in the powder mixture before milling. The milled iron containing powder mixture is used as the negative electrode in an assembled cell. In some embodiments, the mixed positive electrode powders are coated on both sides of the current collector with the powder thickness of 200 micron on each side of the current collectors. In some embodiments, the mixed negative electrode powders are coated on both sides of the current collector with the powder thickness of 200 micron on each side of the current collectors. According to various embodiments, the current collectors are nickel coated carbon steel with less than 10 micron thick nickel coating. In some embodiments, the current collectors are 10 micron thick. In some embodiments, hydrophilic polypropylene battery separator such as Celgard 3501 is placed between the positive electrode and the negative electrode. In some embodiments, the electrode porosity is between 20% and 30%. In some embodiments, the active area of the electrodes are 1000 cm2. In some embodiments, the cell-level energy density is higher than 50 Wh/L. In certain embodiments, the cell-level energy density is 55 Wh/L. In certain embodiments, the cell-level energy cost is $100/kWh.

In certain embodiments the electrolyte is a near-neutral aqueous solution, in which the pH is between 4 and 10. In certain embodiments the electrolyte is a sulfate or chloride solution such as Li₂SO₄, Na₂SO₄, K₂SO₄, CuSO₄, NaCl, LiCl, KCl, CuCl₂, or combinations thereof, dissolved in water.

Various embodiments may provide devices and/or methods for use in bulk energy storage systems, such as long duration energy storage (LODES) systems, short duration energy storage (SDES) systems, etc. As an example, various embodiments may provide batteries for bulk energy storage systems, such as batteries for LODES systems. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

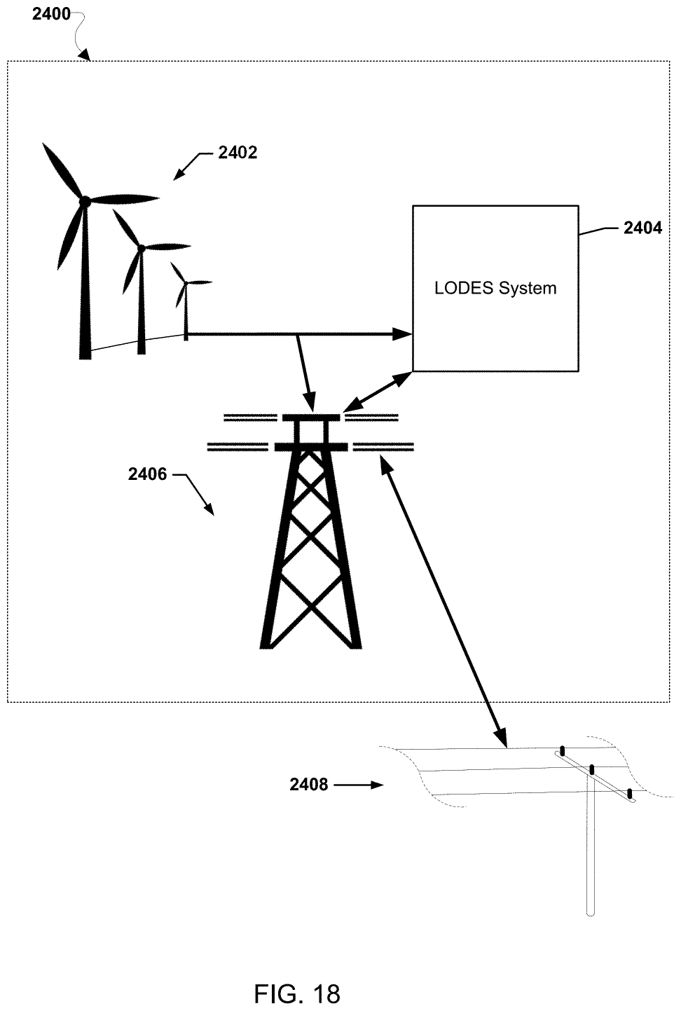

FIGS. 18-26 illustrate various example systems in which one or more aspects of the various embodiments may be used as part of bulk energy storage systems, such as LODES systems, SDES systems, etc. For example, various embodiments described herein with reference to FIGS. 1A-17 may be used as batteries for bulk energy storage systems, such as LODES systems, SDES systems, etc. and/or various electrodes as described herein may be used as components for bulk energy storage systems. As specific examples, electrochemical cells 100, 190, 300, 400, 500, 600, and/or 700 of FIGS. 1A-7 may be used as batteries for bulk energy storage systems, such as LODES systems, SDES systems, etc. as described with reference to FIGS. 18-26. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h. a duration of 24 h to 150 h, a duration of greater than 150 h, a duration of 24 h to 200 h, a duration greater than 200 h, a duration of 24 h to 500 h, a duration greater than 500 h, etc.

FIG. 18 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a wind farm 2402 and one or more transmission facilities 2406. The wind farm 2402 may be electrically connected to the transmission facilities 2406. The transmission facilities 2406 may be electrically connected to the grid 2408. The wind farm 2402 may generate power and the wind farm 2402 may output generated power to the LODES system 2404 and/or the transmission facilities 2406. The LODES system 2404 may store power received from the wind farm 2402 and/or the transmission facilities 2406. The LODES system 2404 may output stored power to the transmission facilities 2406. The transmission facilities 2406 may output power received from one or both of the wind farm 2402 and LODES system 2404 to the grid 2408 and/or may receive power from the grid 2408 and output that power to the LODES system 2404. Together the wind farm 2402, the LODES system 2404, and the transmission facilities 2406 may constitute a power plant 2400 that may be a combined power generation, transmission, and storage system. The power generated by the wind farm 2402 may be directly fed to the grid 2408 through the transmission facilities 2406, or may be first stored in the LODES system 2404. In certain cases the power supplied to the grid 2408 may come entirely from the wind farm 2402, entirely from the LODES system 2404, or from a combination of the wind farm 2402 and the LODES system 2404. The dispatch of power from the combined wind farm 2402 and LODES system 2404 power plant 2400 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2400, the LODES system 2404 may be used to reshape and “firm” the power produced by the wind farm 2402. In one such example, the wind farm 2402 may have a peak generation output (capacity) of 260 megawatts (MW) and a capacity factor (CF) of 41%. The LODES system 2404 may have a power rating (capacity) of 106 MW, a rated duration (energy/power ratio) of 150 hours (h), and an energy rating of 15,900 megawatt hours (MWh). In another such example, the wind farm 2402 may have a peak generation output (capacity) of 300 MW and a capacity factor (CF) of 41%. The LODES system 2404 may have a power rating of 106 MW, a rated duration (energy/power ratio) of 200 h and an energy rating of 21,200 MWh. In another such example, the wind farm 2402 may have a peak generation output (capacity) of 176 MW and a capacity factor (CF) of 53%. The LODES system 2404 may have a power rating (capacity) of 88 MW, a rated duration (energy/power ratio) of 150 h and an energy rating of 13,200 MWh. In another such example, the wind farm 2402 may have a peak generation output (capacity) of 277 MW and a capacity factor (CF) of 41%. The LODES system 2404 may have a power rating (capacity) of 97 MW, a rated duration (energy/power ratio) of 50 h and an energy rating of 4,850 MWh. In another such example, the wind farm 2402 may have a peak generation output (capacity) of 315 MW and a capacity factor (CF) of 41%. The LODES system 2404 may have a power rating (capacity) of 110 MW, a rated duration (energy/power ratio) of 25 h and an energy rating of 2,750 MWh.

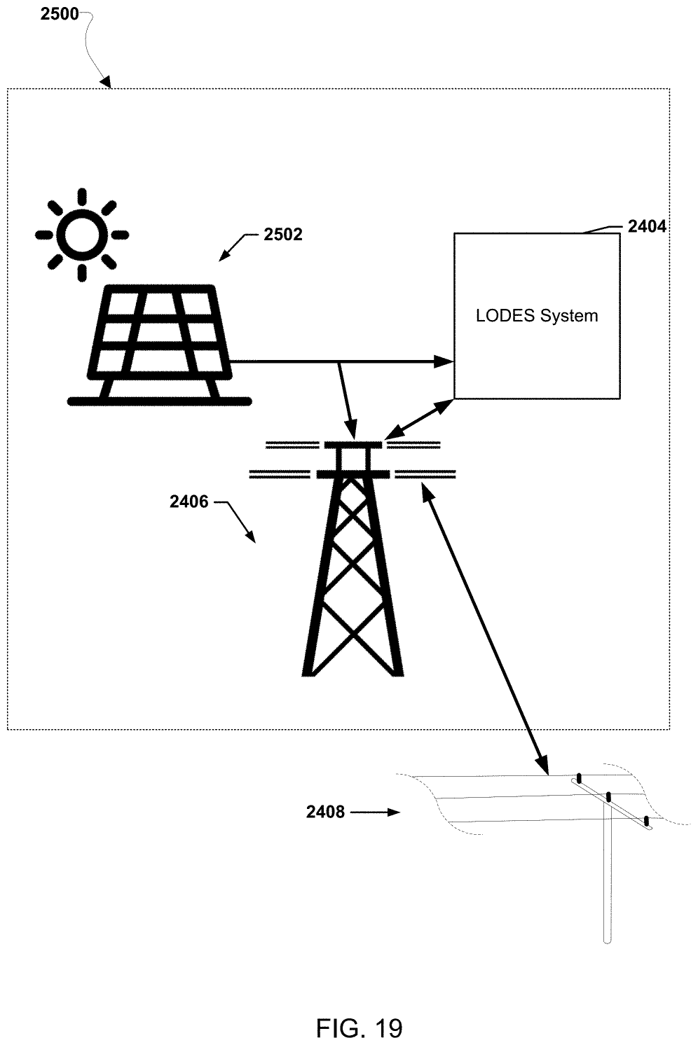

FIG. 19 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The system of FIG. 19 may be similar to the system of FIG. 18, except a photovoltaic (PV) farm 2502 may be substituted for the wind farm 2402. The LODES system 2404 may be electrically connected to the PV farm 2502 and one or more transmission facilities 2406. The PV farm 2502 may be electrically connected to the transmission facilities 2406. The transmission facilities 2406 may be electrically connected to the grid 2408. The PV farm 2502 may generate power and the PV farm 2502 may output generated power to the LODES system 2404 and/or the transmission facilities 2406. The LODES system 2404 may store power received from the PV farm 2502 and/or the transmission facilities 2406. The LODES system 2404 may output stored power to the transmission facilities 2406. The transmission facilities 2406 may output power received from one or both of the PV farm 2502 and LODES system 2404 to the grid 2408 and/or may receive power from the grid 2408 and output that power to the LODES system 2404. Together the PV farm 2502, the LODES system 2404, and the transmission facilities 2406 may constitute a power plant 2500 that may be a combined power generation, transmission, and storage system. The power generated by the PV farm 2502 may be directly fed to the grid 2408 through the transmission facilities 2406, or may be first stored in the LODES system 2404. In certain cases the power supplied to the grid 2408 may come entirely from the PV farm 2502, entirely from the LODES system 2404, or from a combination of the PV farm 2502 and the LODES system 2404. The dispatch of power from the combined PV farm 2502 and LODES system 2404 power plant 2500 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2500, the LODES system 2404 may be used to reshape and “firm” the power produced by the PV farm 2502. In one such example, the PV farm 2502 may have a peak generation output (capacity) of 490 MW and a capacity factor (CF) of 24%. The LODES system 2404 may have a power rating (capacity) of 340 MW, a rated duration (energy/power ratio) of 150 h and an energy rating of 51,000 MWh. In another such example, the PV farm 2502 may have a peak generation output (capacity) of 680 MW and a capacity factor (CF) of 24%. The LODES system 2404 may have a power rating (capacity) of 410 MW, a rated duration (energy/power ratio) of 20 h, and an energy rating of 82,000 MWh. In another such example, the PV farm 2502 may have a peak generation output (capacity) of 330 MW and a capacity factor (CF) of 31%. The LODES system 2404 may have a power rating (capacity) of 215 MW, a rated duration (energy/power ratio) of 150 h, and an energy rating of 32,250 MWh. In another such example, the PV farm 2502 may have a peak generation output (capacity) of 510 MW and a capacity factor (CF) of 24%. The LODES system 2404 may have a power rating (capacity) of 380 MW, a rated duration (energy/power ratio) of 50 h, and an energy rating of 19,000 MWh. In another such example, the PV farm 2502 may have a peak generation output (capacity) of 630 MW and a capacity factor (CF) of 24%. The LODES system 2404 may have a power rating (capacity) of 380 MW, a rated duration (energy/power ratio) of 25 h, and an energy rating of 9,500 MWh.

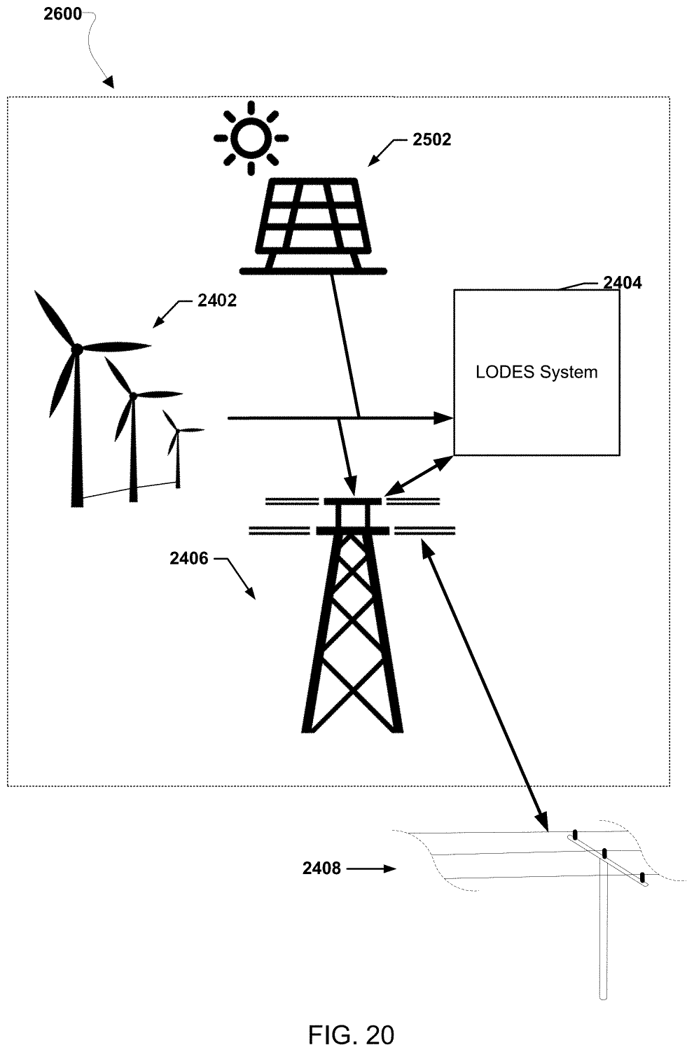

FIG. 20 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The system of FIG. 20 may be similar to the systems of FIGS. 18 and 19, except the wind farm 2402 and the photovoltaic (PV) farm 2502 may both be power generators working together in the power plant 2600. Together the PV farm 2502, wind farm 2402, the LODES system 2404, and the transmission facilities 2406 may constitute the power plant 2600 that may be a combined power generation, transmission, and storage system. The power generated by the PV farm 2502 and/or the wind farm 2402 may be directly fed to the grid 2408 through the transmission facilities 2406, or may be first stored in the LODES system 2404. In certain cases the power supplied to the grid 2408 may come entirely from the PV farm 2502, entirely from the wind farm 2402, entirely from the LODES system 2404, or from a combination of the PV farm 2502, the wind farm 2402, and the LODES system 2404. The dispatch of power from the combined wind farm 2402, PV farm 2502, and LODES system 2404 power plant 2600 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2600, the LODES system 2404 may be used to reshape and “firm” the power produced by the wind farm 2402 and the PV farm 2502. In one such example, the wind farm 2402 may have a peak generation output (capacity) of 126 MW and a capacity factor (CF) of 41% and the PV farm 2502 may have a peak generation output (capacity) of 126 MW and a capacity factor (CF) of 24%. The LODES system 2404 may have a power rating (capacity) of 63 MW, a rated duration (energy/power ratio) of 150 h, and an energy rating of 9,450 MWh. In another such example, the wind farm 2402 may have a peak generation output (capacity) of 170 MW and a capacity factor (CF) of 41% and the PV farm 2502 may have a peak generation output (capacity) of 110 MW and a capacity factor (CF) of 24%. The LODES system 2404 may have a power rating (capacity) of 57 MW, a rated duration (energy/power ratio) of 200 h, and an energy rating of 11,400 MWh. In another such example, the wind farm 2402 may have a peak generation output (capacity) of 105 MW and a capacity factor (CF) of 51% and the PV farm 2502 may have a peak generation output (capacity) of 70 MW and a capacity factor (CF) of 31 The LODES system 2404 may have a power rating (capacity) of 61 MW, a rated duration (energy/power ratio) of 150 h, and an energy rating of 9,150 MWh. In another such example, the wind farm 2402 may have a peak generation output (capacity) of 135 MW and a capacity factor (CF) of 41% and the PV farm 2502 may have a peak generation output (capacity) of 90 MW and a capacity factor (CF) of 24%. The LODES system 2404 may have a power rating (capacity) of 68 MW, a rated duration (energy/power ratio) of 50 h, and an energy rating of 3,400 MWh. In another such example, the wind farm 2402 may have a peak generation output (capacity) of 144 MW and a capacity factor (CF) of 41% and the PV farm 2502 may have a peak generation output (capacity) of 96 MW and a capacity factor (CF) of 24%. The LODES system 2404 may have a power rating (capacity) of 72 MW, a rated duration (energy/power ratio) of 25 h, and an energy rating of 1,800 MWh.

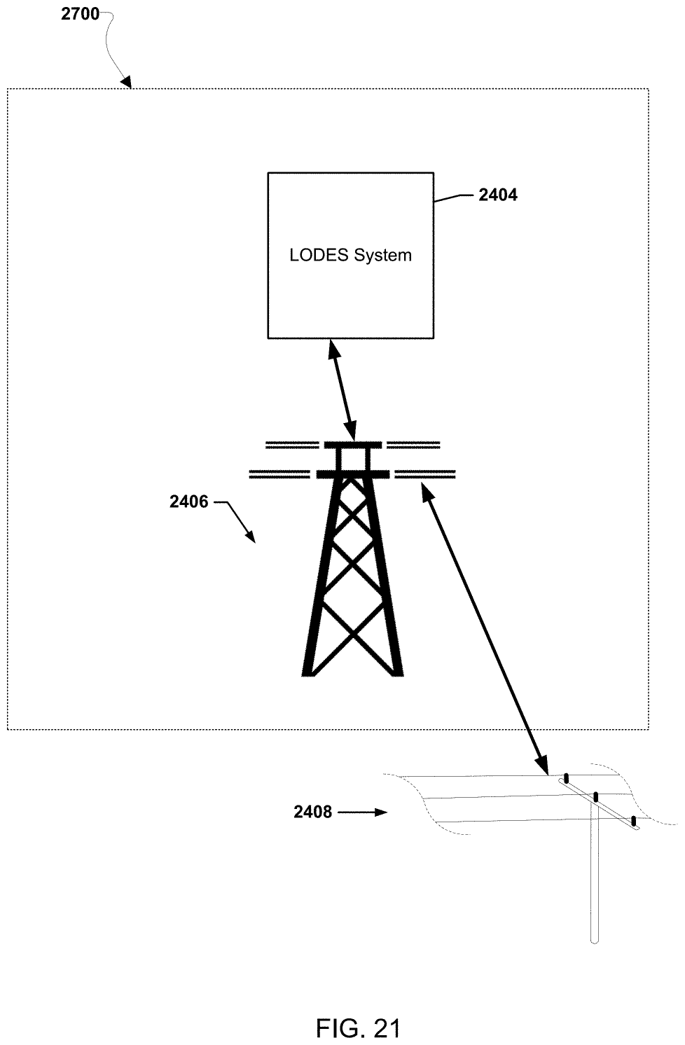

FIG. 21 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to one or more transmission facilities 2406. In this manner, the LODES system 2404 may operate in a “stand-alone” manner to arbiter energy around market prices and/or to avoid transmission constraints. The LODES system 2404 may be electrically connected to one or more transmission facilities 2406. The transmission facilities 2406 may be electrically connected to the grid 2408. The LODES system 2404 may store power received from the transmission facilities 2406. The LODES system 2404 may output stored power to the transmission facilities 2406. The transmission facilities 2406 may output power received from the LODES system 2404 to the grid 2408 and/or may receive power from the grid 2408 and output that power to the LODES system 2404.

Together the LODES system 2404 and the transmission facilities 2406 may constitute a power plant 2700. As an example, the power plant 2700 may be situated downstream of a transmission constraint, close to electrical consumption. In such an example downstream situated power plant 2700, the LODES system 2404 may have a duration of 24 h to 500 h and may undergo one or more full discharges a year to support peak electrical consumptions at times when the transmission capacity is not sufficient to serve customers. Additionally, in such an example downstream situated power plant 2700, the LODES system 2404 may undergo several shallow discharges (daily or at higher frequency) to arbiter the difference between nighttime and daytime electricity prices and reduce the overall cost of electrical service to customer. As a further example, the power plant 2700 may be situated upstream of a transmission constraint, close to electrical generation. In such an example upstream situated power plant 2700, the LODES system 2404 may have a duration of 24 h to 500 h and may undergo one or more full charges a year to absorb excess generation at times when the transmission capacity is not sufficient to distribute the electricity to customers. Additionally in such an example upstream situated power plant 2700, the LODES system 2404 may undergo several shallow charges and discharges (daily or at higher frequency) to arbiter the difference between nighttime and daytime electricity prices and maximize the value of the output of the generation facilities.

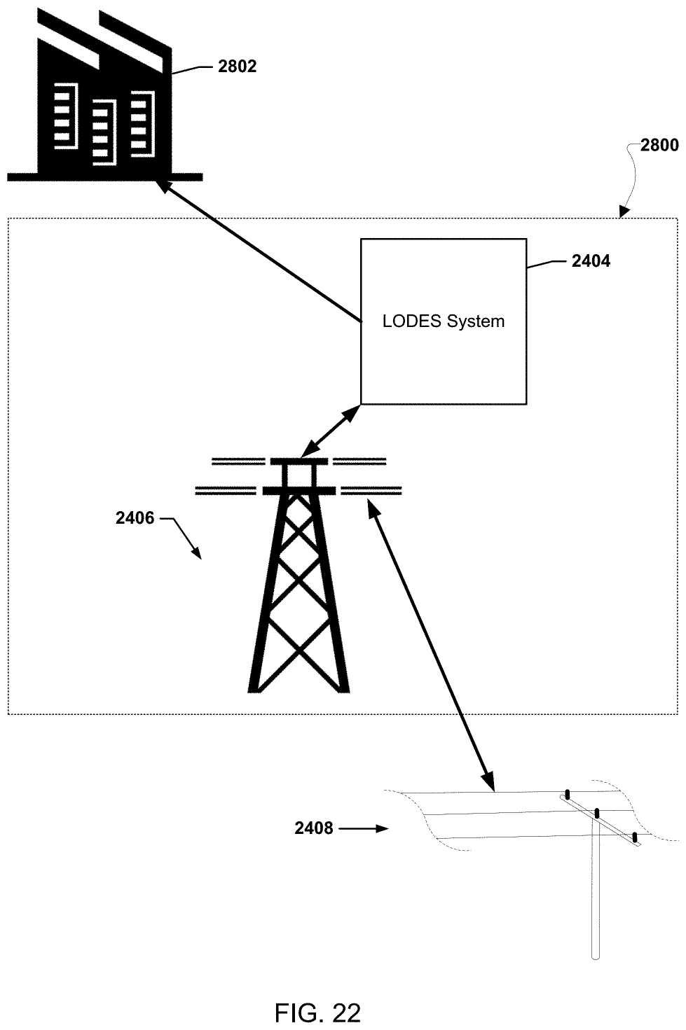

FIG. 22 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a commercial and industrial (C&I) customer 2802, such as a data center, factory, etc. The LODES system 2404 may be electrically connected to one or more transmission facilities 2406. The transmission facilities 2406 may be electrically connected to the grid 2408. The transmission facilities 2406 may receive power from the grid 2408 and output that power to the LODES system 2404. The LODES system 2404 may store power received from the transmission facilities 2406. The LODES system 2404 may output stored power to the C&I customer 2802. In this manner, the LODES system 2404 may operate to reshape electricity purchased from the grid 2408 to match the consumption pattern of the C&I customer 2802.

Together, the LODES system 2404 and transmission facilities 2406 may constitute a power plant 2800. As an example, the power plant 2800 may be situated close to electrical consumption, i.e., close to the C&I customer 2802, such as between the grid 2408 and the C&I customer 2802. In such an example, the LODES system 2404 may have a duration of 24 h to 500 h and may buy electricity from the markets and thereby charge the LODES system 2404 at times when the electricity is cheaper. The LODES system 2404 may then discharge to provide the C&I customer 2802 with electricity at times when the market price is expensive, therefore offsetting the market purchases of the C&I customer 2802. As an alternative configuration, rather than being situated between the grid 2408 and the C&I customer 2802, the power plant 2800 may be situated between a renewable source, such as a PV farm, wind farm, etc., and the transmission facilities 2406 may connect to the renewable source. In such an alternative example, the LODES system 2404 may have a duration of 24 h to 500 h, and the LODES system 2404 may charge at times when renewable output may be available. The LODES system 2404 may then discharge to provide the C&I customer 2802 with renewable generated electricity so as to cover a portion, or the entirety, of the C&I customer 2802 electricity needs.

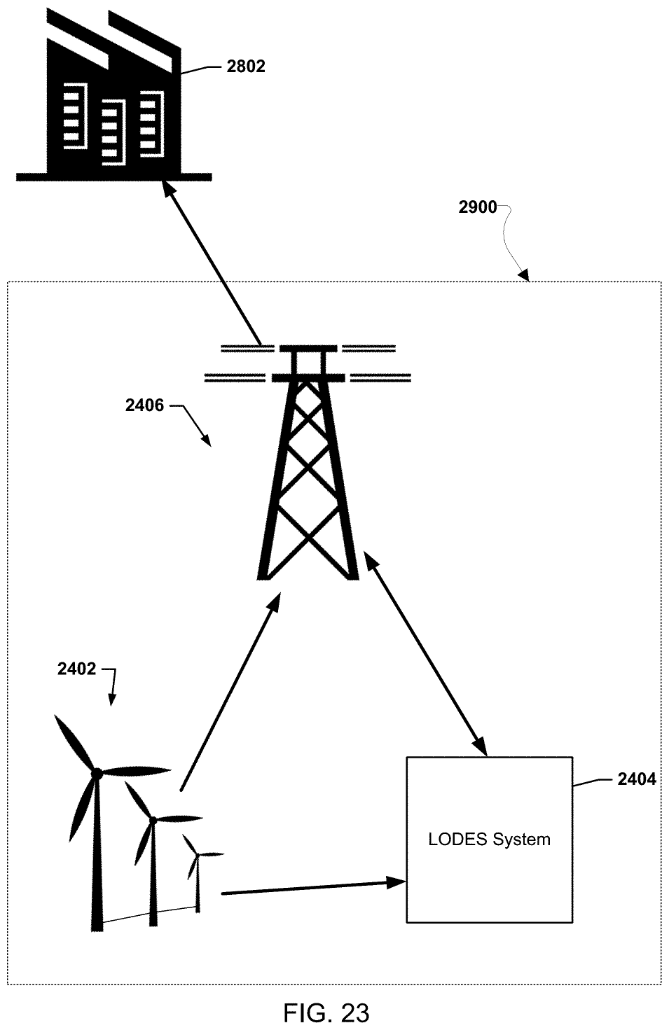

FIG. 23 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a wind farm 2402 and one or more transmission facilities 2406. The wind farm 2402 may be electrically connected to the transmission facilities 2406. The transmission facilities 2406 may be electrically connected to a C&I customer 2802. The wind farm 2402 may generate power and the wind farm 2402 may output generated power to the LODES system 2404 and/or the transmission facilities 2406. The LODES system 2404 may store power received from the wind farm 2402.

The LODES system 2404 may output stored power to the transmission facilities 2406. The transmission facilities 2406 may output power received from one or both of the wind farm 2402 and LODES system 2404 to the C&I customer 2802. Together the wind farm 2402, the LODES system 2404, and the transmission facilities 2406 may constitute a power plant 2900 that may be a combined power generation, transmission, and storage system. The power generated by the wind farm 2402 may be directly fed to the C&I customer 2802 through the transmission facilities 2406, or may be first stored in the LODES system 2404. In certain cases, the power supplied to the C&I customer 2802 may come entirely from the wind farm 2402, entirely from the LODES system 2404, or from a combination of the wind farm 2402 and the LODES system 2404. The LODES system 2404 may be used to reshape the electricity generated by the wind farm 2402 to match the consumption pattern of the C&I customer 2802. In one such example, the LODES system 2404 may have a duration of 24 h to 500 h and may charge when renewable generation by the wind farm 2402 exceeds the C&I customer 2802 load. The LODES system 2404 may then discharge when renewable generation by the wind farm 2402 falls short of C&I customer 2802 load so as to provide the C&I customer 2802 with a firm renewable profile that offsets a fraction, or all of, the C&I customer 2802 electrical consumption.

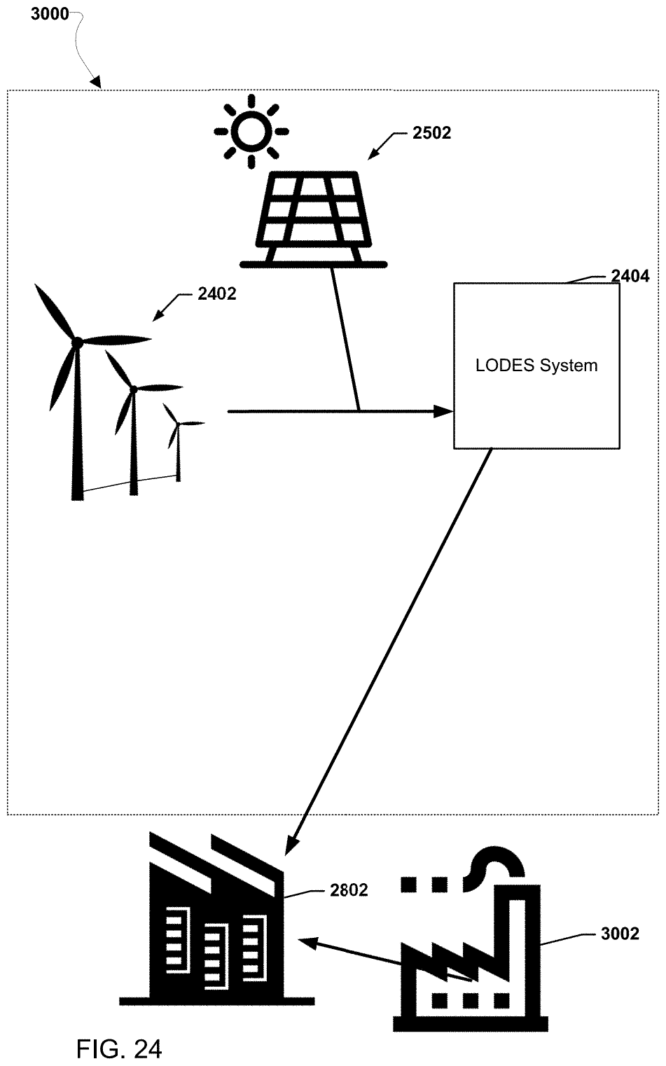

FIG. 24 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be part of a power plant 3000 that is used to integrate large amounts of renewable generation in microgrids and harmonize the output of renewable generation by, for example a PV farm 2502 and wind farm 2402, with existing thermal generation by, for example a thermal power plant 3002 (e.g., a gas plant, a coal plant, a diesel generator set, etc., or a combination of thermal generation methods), while renewable generation and thermal generation supply the C&I customer 2802 load at high availability. Microgrids, such as the microgrid constituted by the power plant 3000 and the thermal power plant 3002, may provide availability that is 90% or higher. The power generated by the PV farm 2502 and/or the wind farm 2402 may be directly fed to the C&I customer 2802, or may be first stored in the LODES system 2404.

In certain cases the power supplied to the C&I customer 2802 may come entirely from the PV farm 2502, entirely from the wind farm 2402, entirely from the LODES system 2404, entirely from the thermal power plant 3002, or from any combination of the PV farm 2502, the wind farm 2402, the LODES system 2404, and/or the thermal power plant 3002. As examples, the LODES system 2404 of the power plant 3000 may have a duration of 24 h to 500 h. As a specific example, the C&I customer 2802 load may have a peak of 100 MW, the LODES system 2404 may have a power rating of 14 MW and duration of 150 h, natural gas may cost $6/million British thermal units (MMBTU), and the renewable penetration may be 58%. As another specific example, the C&I customer 2802 load may have a peak of 100 MW, the LODES system 2404 may have a power rating of 25 MW and duration of 150 h, natural gas may cost $8/MMBTU, and the renewable penetration may be 65%.

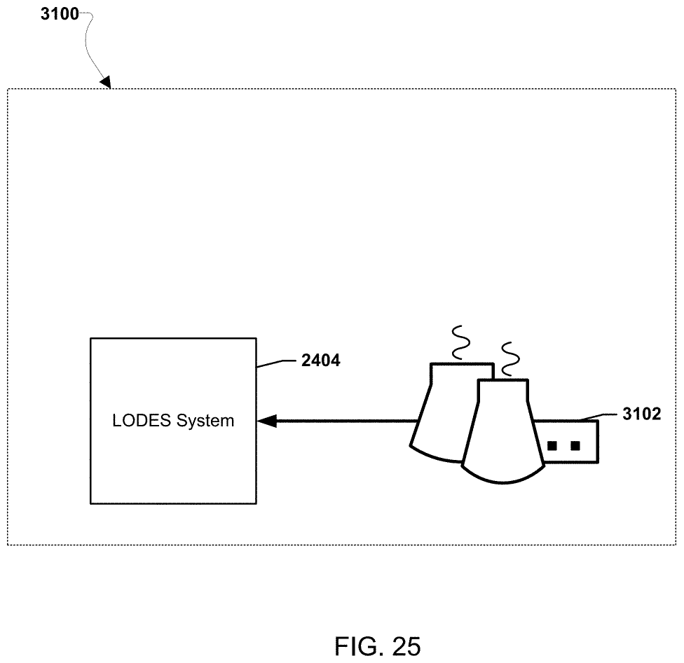

FIG. 25 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be used to augment a nuclear plant 3102 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 3100 constituted by the combined LODES system 2404 and nuclear plant 3102. The nuclear plant 3102 may operate at high capacity factor and at the highest efficiency point, while the LODES system 2404 may charge and discharge to effectively reshape the output of the nuclear plant 3102 to match a customer electrical consumption and/or a market price of electricity. As examples, the LODES system 2404 of the power plant 3100 may have a duration of 24 h to 500 h. In one specific example, the nuclear plant 3102 may have 1,000 MW of rated output and the nuclear plant 3102 may be forced into prolonged periods of minimum stable generation or even shutdowns because of depressed market pricing of electricity. The LODES system 2404 may avoid facility shutdowns and charge at times of depressed market pricing; and the LODES system 2404 may subsequently discharge and boost total output generation at times of inflated market pricing.

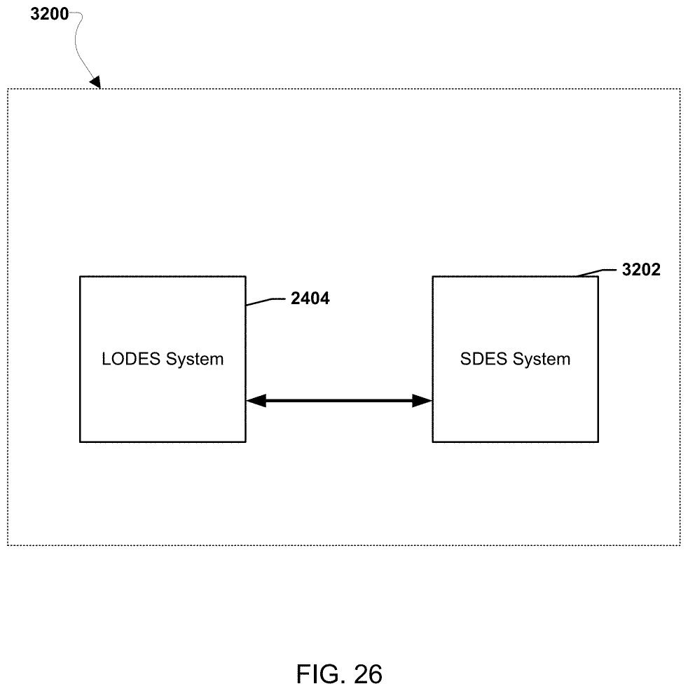

FIG. 26 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may operate in tandem with a SDES system 3202. Together the LODES system 2404 and SDES system 3202 may constitute a power plant 3200. As an example, the LODES system 2404 and SDES system 3202 may be co-optimized whereby the LODES system 2404 may provide various services, including long-duration back-up and/or bridging through multi-day fluctuations (e.g., multi-day fluctuations in market pricing, renewable generation, electrical consumption, etc.), and the SDES system 3202 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 3202 may have durations of less than 10 hours and round-trip efficiencies of greater than 80%. The LODES system 2404 may have durations of 24 h to 500 h and round-trip efficiencies of greater than 40%. In one such example, the LODES system 2404 may have a duration of 150 hours and support customer electrical consumption for up to a week of renewable under-generation. The LODES system 2404 may also support customer electrical consumption during intra-day under-generation events, augmenting the capabilities of the SDES system 3202. Further, the SDES system 3202 may supply customers during intra-day under-generation events and provide power conditioning and quality services such as voltage control and frequency regulation.

Various embodiments may include example hydrogen oxidation reaction (HOR) electrodes as described below. Various embodiments may include example electrochemical cells as described below. Various embodiments may include a bulk energy storage system as described below.

Example 1. A hydrogen oxidation reaction (HOR) electrode comprising: a substrate; and a catalyst layer disposed on the substrate.

Example 2. The HOR electrode of example 1, wherein the catalyst layer comprises a catalyst represented by the formula: M1ₓM2_{y}M3_{z}, wherein: x+y+z=1; M1 comprises a first transition metal; M2 comprises a second transition metal; and M3 comprises a third transition metal or metalloid.

Example 3. The HOR electrode of example 2, wherein M1 comprises Ni, M2 comprises Mo, Co, or combinations thereof, and M3 comprises C, Cu, N, Si, Al or combinations thereof.

Example 4. The HOR electrode of any of examples 1-3, wherein the catalyst layer comprises nickel nanoparticles supported on carbon nanotubes.

Example 5. The HOR electrode of any of examples 1-3, wherein: the catalyst layer comprises Ni, Al, and a transition metal (MT), at an Ni:Al:MT weight percent ratio of about 49:49:2; and MT comprises Fe, Cu, Ti, Cr, La. or combinations thereof.

Example 6. An electrochemical cell comprising: a battery negative electrode; a hydrogen oxidation reaction (HOR) electrode; an oxygen evolution reaction (OER) electrode; an oxygen reduction reaction (ORR) electrode; and an electrolyte.

Example 7a. The electrochemical cell of example 6, wherein the battery negative electrode, OER electrode, and ORR electrode are all disposed in the electrolyte.

Example 7b. The electrochemical cell of example 6, wherein the battery negative electrode, HOR electrode, OER electrode, and ORR electrode are all disposed in the electrolyte.

Example 8. The electrochemical cell of any of examples 6-7b, wherein the battery negative electrode comprises Fe, Zn, Mg, Al, or Cd.

Example 9. The electrochemical cell of any of examples 6-8, wherein the battery negative electrode comprises direct reduced iron (DRI), sponge iron, atomized iron, or carbonyl iron.

Example 10. The electrochemical cell of any of examples 6-9, wherein: the OER electrode comprises a metal; and the HOR electrode comprises a metal, a metal and a catalyst, carbon, or carbon and a catalyst.

Example 11. The electrochemical cell of any of examples 6-10, wherein the cell is configured to direct hydrogen gas from the battery negative electrode to the HOR electrode.

Example 12. The electrochemical cell of any of examples 6-11, wherein the electrolyte comprises water and one or more hydroxide salts.

Example 13. An electrochemical cell comprising: a first electrode; a second electrode; and a third electrode, wherein at least one of the first electrode, the second electrode, and the third electrode are configured to operate as a battery negative electrode or a hydrogen oxidation reaction (HOR) electrode when the electrochemical cell is operating in a charge mode.

Example 14. The electrochemical cell of example 13, wherein the first electrode operates as the battery negative electrode in the charge mode and the second electrode operates as an oxygen evolution reaction (OER) electrode in the charge mode.

Example 15. The electrochemical cell of any of examples 13-14, wherein the third electrode is a dual hydrogen oxidation reaction (HOR) electrode and an oxygen reduction reaction (ORR) electrode.

Example 16. The electrochemical cell of any of examples 13-15, wherein the third electrode is an oxygen reduction reaction (ORR) electrode.

Example 17. The electrochemical cell of any of examples 13-16, wherein: the second electrode operates as a HOR electrode and the third electrode operates as an oxygen reduction reaction (ORR) electrode in a discharge mode, and the second electrode operates as an oxygen evolution reaction (OER) electrode and the third electrode operates as a HOR electrode in the charge mode.

Example 18. The electrochemical cell of any of examples 13-17, wherein the first electrode comprises Fe, Zn, Mg, Al, or Cd.

Example 19. The electrochemical cell of any of examples 13-18, wherein the first electrode comprises direct reduced iron (DRI), sponge iron, atomized iron, or carbonyl iron.

Example 20. The electrochemical cell of any of examples 13-19, wherein the first electrode operates as the battery negative electrode in both the charge and discharge mode and the second electrode operates as a battery positive electrode in both charge and discharge mode.

Example 21. The electrochemical cell of any of examples 13-20, wherein the second electrode is comprised of manganese dioxide, carbon, and a polymeric binder.

Example 22. The electrochemical cell of any of examples 13-21, wherein the cell is configured to direct hydrogen gas to an electrode operating as the HOR electrode.

Example 23. The electrochemical cell of any of examples 13-21, wherein the electrolyte comprises water and one or more hydroxide salts.

Example 24. The electrochemical cell and/or HOR electrode of any of examples 1-23, wherein the catalyst and/or catalyst layer comprises a noble metal.

Example 25. The electrochemical cell and/or HOR electrode of example 24, wherein the catalyst and/or catalyst layer comprises Pt, Pd, Au, and/or Ag.

Example 26. The electrochemical cell and/or HOR electrode of any of examples 23-25, wherein the catalyst and/or catalyst layer comprises the noble metal mixed with electronically conductive carbon.

Example 27. The electrochemical cell and/or HOR electrode of any of examples 23-26, wherein the catalyst and/or catalyst layer comprises the noble metal and another one or more metal catalysts.

Example 28. The electrochemical cell and/or HOR electrode of example 27, wherein the one or more metal catalysts are transition metals.

Example 29. The electrochemical cell and/or HOR electrode of example 27, wherein the one or more metal catalysts comprise Ni.

Example 30. An electrochemical cell, comprising: a mechanical housing or vessel; and a hydrogen absorption or storage material disposed within the mechanical housing or vessel.

Example 31. The electrochemical cell of example 30, wherein the hydrogen absorption or storage material is coated or attached to an inside face of the mechanical housing or vessel, the hydrogen absorption or storage material is coated on the inside of a lid or vertically oriented inner wall of the electrochemical cell, the hydrogen absorption or storage material is contained in a box or cartridge having vents that allow hydrogen gas to permeate to the hydrogen absorption or storage material therein, and/or the hydrogen storage material is mixed with or impregnated into an electrode of the electrochemical cell.

Example 32. The electrochemical cell of any of examples 30-31, wherein the hydrogen absorption or storage material is a metal hydride.

Example 33. The electrochemical cell of example 32, wherein the hydrogen absorption or storage material is MgH₂, NaAlH₄, LiAH₄, LiH, LaNi₅H₆, TiFeH₂, LiNH₂, LiBH₄, NaBH₄, ammonia borane, or palladium hydride.

Example 34. The electrochemical cell of any of examples 30-31, wherein the hydrogen absorption or storage material is an organic molecule.

Example 35. The electrochemical cell of example 34, wherein the hydrogen absorption or storage material is N-ethylcarbazole.

Example 36. The electrochemical cell of any of examples 30-35, wherein: the electrochemical cell is the electrochemical cell of any of examples 1-29; and/or the electrochemical cell includes the HOR electrode of any of examples 1-29.

Example 37. A bulk energy storage system, comprising: one or more electrochemical cells of any of examples 1-36; and/or one or more of the electrochemical cells includes the HOR electrode of any of examples 1-36.

Example 38. The bulk energy storage system of example 37, wherein the bulk energy storage system is a long duration energy storage (LODES) system.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular. Further, any step of any embodiment described herein can be used in any other embodiment.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

The preceding description of the disclosed embodiments is provided to enable any person skilled in the art to make or use the described embodiment. Various modifications to these embodiments will be readily apparent to those skilled in the art, and the generic principles defined herein may be applied to other embodiments without departing from the scope of the disclosure. Thus, the present invention is not intended to be limited to the embodiments shown herein but is to be accorded the widest scope consistent with the following claims and the principles and novel features disclosed herein.

What is claimed is:

1. A hydrogen oxidation reaction (HOR) electrode comprising:
a substrate; and
a catalyst layer disposed on the substrate.

2. The HOR electrode of claim 1, wherein the catalyst layer comprises a catalyst represented by the formula:
M1ₓM2_{y}M3_{z},
wherein:
x+y+z=1;
M1 comprises a first transition metal;
M2 comprises a second transition metal; and
M3 comprises a third transition metal or metalloid.

3. The HOR electrode of claim 2, wherein M1 is comprises Ni, M2 comprises Mo, Co, or combinations thereof, and M3 comprises C, Cu, N, Si, Al, or combinations thereof.

4. The HOR electrode of claim 1, wherein the catalyst layer comprises nickel nanoparticles supported on carbon nanotubes.

5. The HOR electrode of claim 1, wherein:
the catalyst layer comprises Ni, Al, and a transition metal (MT), at an Ni:Al:MT weight percent ratio of about 49:49:2; and
MT comprises Fe, Cu, Ti, Cr, La, or combinations thereof.

6. The HOR electrode of claim 1, wherein the catalyst layer comprises a noble metal.

7. The HOR electrode of claim 6, wherein the catalyst layer comprises Pt, Pd, Au, and/or Ag.

8. The HOR electrode of claim 6, wherein the catalyst layer comprises the noble metal mixed with electronically conductive carbon.

9. The HOR electrode of claim 6, wherein the catalyst layer comprises the noble metal and another one or more metal catalysts.

10. The HOR electrode of claim 9, wherein the one or more metal catalysts are transition metals.

11. The HOR electrode of claim 9, wherein the one or more metal catalysts comprise Ni.

12. An electrochemical cell comprising:
a battery negative electrode;
a hydrogen oxidation reaction (HOR) electrode;
an oxygen evolution reaction (OER) electrode;
an oxygen reduction reaction (ORR) electrode; and
an electrolyte.

13. The electrochemical cell of claim 12, wherein the battery negative electrode, OER electrode, and ORR electrode are all disposed in the electrolyte.

14. The electrochemical cell of claim 12, wherein the battery negative electrode, HOR electrode, OER electrode, and ORR electrode are all disposed in the electrolyte.

15. The electrochemical cell of claim 13, wherein the battery negative electrode comprises Fe, Zn, Mg, Al, or Cd.

16. The electrochemical cell of claim 13, wherein the battery negative electrode comprises direct reduced iron (DRI), sponge iron, atomized iron, or carbonyl iron.

17. The electrochemical cell of claim 16, wherein:
the OER electrode comprises a metal; and
the HOR electrode comprises a metal, a metal and a catalyst, carbon, or carbon and a catalyst.

18. The electrochemical cell of claim 17, wherein the cell is configured to direct hydrogen gas from the battery negative electrode to the HOR electrode.

19. The electrochemical cell of claim 18, wherein the electrolyte comprises water and one or more hydroxide salts.

20. An electrochemical cell comprising:
a first electrode;
a second electrode; and
a third electrode,
wherein at least one of the first electrode, the second electrode, and the third electrode are configured to operate as a battery negative electrode or a hydrogen oxidation reaction (HOR) electrode when the electrochemical cell is operating in a charge mode.

21. The electrochemical cell of claim 20, wherein the first electrode operates as the battery negative electrode in the charge mode and the second electrode operates as an oxygen evolution reaction (OER) electrode in the charge mode.

22. The electrochemical cell of claim 20, wherein the third electrode is a dual hydrogen oxidation reaction (HOR) electrode and an oxygen reduction reaction (ORR) electrode.

23. The electrochemical cell of claim 20, wherein the third electrode is an oxygen reduction reaction (ORR) electrode.

24. The electrochemical cell of claim 20, wherein:
the second electrode operates as a HOR electrode and the third electrode operates as an oxygen reduction reaction (ORR) electrode in a discharge mode; and
the second electrode operates as an oxygen evolution reaction (OER) electrode and the third electrode operates as a HOR electrode in the charge mode.

25. The electrochemical cell of claim 24, wherein the first electrode comprises Fe, Zn, Mg, Al, or Cd.

26. The electrochemical cell of claim 24, wherein the first electrode comprises direct reduced iron (DRI), sponge iron, atomized iron, or carbonyl iron.

27. The electrochemical cell of claim 20, wherein the first electrode operates as the battery negative electrode in both the charge and discharge mode and the second electrode operates as a battery positive electrode in both charge and discharge mode.

28. The electrochemical cell of claim 27, wherein the second electrode is comprised of manganese dioxide, carbon, and a polymeric binder.

29. The electrochemical cell of claim 20, wherein the cell is configured to direct hydrogen gas to an electrode operating as the HOR electrode.

30. The electrochemical cell of claim 29, wherein the electrolyte comprises water and one or more hydroxide salts.

31. The electrochemical cell of claim 20, wherein at least one of the first electrode, the second electrode, and the third electrode comprises a catalyst comprising a noble metal.

32. The electrochemical cell of claim 31, wherein the catalyst comprises Pt, Pd, Au, and/or Ag.

33. The electrochemical cell of claim 31, wherein the catalyst comprises the noble metal mixed with electronically conductive carbon.

34. The electrochemical cell of claim 31, wherein the catalyst comprises the noble metal and another one or more metal catalysts.

35. The electrochemical cell of claim 34, wherein the one or more metal catalysts are transition metals.

36. The electrochemical cell of claim 34, wherein the one or more metal catalysts comprise Ni.

37. An electrochemical cell, comprising:
a mechanical housing or vessel; and
a hydrogen absorption or storage material disposed within the mechanical housing or vessel.

38. The electrochemical cell of claim 37, wherein the hydrogen absorption or storage material is coated or attached to an inside face of the mechanical housing or vessel, the hydrogen absorption or storage material is coated on the inside of a lid or vertically oriented inner wall of the electrochemical cell, the hydrogen absorption or storage material is contained in a box or cartridge having vents that allow hydrogen gas to permeate to the hydrogen absorption or storage material therein, or the hydrogen absorption or storage material is mixed with or impregnated into an electrode of the electrochemical cell.

39. The electrochemical cell of claim 38, wherein the hydrogen absorption or storage material is a metal hydride.

40. The electrochemical cell of claim 39, wherein the hydrogen absorption or storage material is MgH₂, NaAlH₄, LiAH₄, LiH, LaNi₅H₆, TiFeH₂, LiNH₂, LiBH₄, NaBH₄, ammonia borane, or palladium hydride.

41. The electrochemical cell of claim 40, wherein the hydrogen absorption or storage material is an organic molecule.

42. The electrochemical cell of claim 41, wherein the hydrogen absorption or storage material is N-ethylcarbazole.

43. A bulk energy storage system, comprising:
one or more batteries, wherein at least one of the one or more batteries comprises:
a first electrode;
a second electrode; and
a third electrode,
wherein at least one of the first electrode, the second electrode, and the third electrode are configured to operate as a battery negative electrode or a hydrogen oxidation reaction (HOR) electrode when the at least one of the one or more batteries is operating in a charge mode.

44. The bulk energy storage system of claim 43, wherein the bulk energy storage system is a long duration energy storage (LODES) system.

45. The bulk energy storage system of claim 44, wherein the first electrode operates as the battery negative electrode in the charge mode and the second electrode operates as an oxygen evolution reaction (OER) electrode in the charge mode.

46. The bulk energy storage system of claim 44, wherein the third electrode is a dual hydrogen oxidation reaction (HOR) electrode and an oxygen reduction reaction (ORR) electrode.

47. The bulk energy storage system of claim 44, wherein the third electrode is an oxygen reduction reaction (ORR) electrode.

48. The bulk energy storage system of claim 44, wherein:
the second electrode operates as a HOR electrode and the third electrode operates as an oxygen reduction reaction (ORR) electrode in a discharge mode; and
the second electrode operates as an oxygen evolution reaction (OER) electrode and the third electrode operates as a HOR electrode in the charge mode.

49. The bulk energy storage system of claim 48, wherein the first electrode comprises Fe, Zn, Mg, Al, or Cd.

50. The bulk energy storage system of claim 48, wherein the first electrode comprises direct reduced iron (DRI), sponge iron, atomized iron, or carbonyl iron.

51. The bulk energy storage system of claim 44, wherein the first electrode operates as the battery negative electrode in both the charge and discharge mode and the second electrode operates as a battery positive electrode in both charge and discharge mode.

52. The bulk energy storage system of claim 51, wherein the second electrode is comprised of manganese dioxide, carbon, and a polymeric binder.

53. The bulk energy storage system of claim 44, wherein the at least one of the one or more batteries further comprises:
a mechanical housing or vessel; and
a hydrogen absorption or storage material disposed within the mechanical housing or vessel.

54. The bulk energy storage system of claim 53, wherein the hydrogen absorption or storage material is coated or attached to an inside face of the mechanical housing or vessel, the hydrogen absorption or storage material is coated on the inside of a lid or vertically oriented inner wall of the electrochemical cell, the hydrogen absorption or storage material is contained in a box or cartridge having vents that allow hydrogen gas to permeate to the hydrogen absorption or storage material therein, or the hydrogen absorption or storage material is mixed with or impregnated into the first, second, or third electrode.
